(19) United States
(12) Patent Application Publication
(10) Pub. No.: US 2016/0070751 A1
(43) Pub. Date: Mar. 10, 2016

(54) DATABASE MANAGEMENT SYSTEM

(71) Applicant: FACE RECORDING AND MEASUREMENTS LTD., Nottingham Nottinghamshire (GB)

(72) Inventors: Paul CLIFFORD, Nottingham (GB); Mark ROBINSON, Nottingham (GB)

(73) Assignee: FACE RECORDING AND MEASUREMENTS LTD., Nottingham, OT (GB)

(21) Appl. No.: 14/786,728

(22) PCT Filed: Apr. 23, 2014
(86) PCT No.: PCT/EP2014/058234

§ 371 Date: Oct. 23, 2015

Related U.S. Application Data
(60) Provisional application No. 61/814,865, filed on Apr. 23, 2013.

(51) Int. Cl. G06F 17/30; G06F 3/0484; G06T 11/20; G06F 3/0482

(52) U.S. Cl. CPC G06F 17/30424; G06F 17/30312; G06F 17/30958; G06F 17/30554; G06F 17/3056; G06F 3/0482; G06F 3/04842; G06T 11/206

(57) ABSTRACT

A method of querying a database with a graphical user interface comprising the steps of: scanning a portion of the database defining a first group, with a database query expression; generating and displaying, in response to the scanning, a set of results defining at least one sub group; allowing a user to select and store the displayed at least one sub group; and allowing a user to select the stored sub group as a group on which at least one query is to be performed.

### TECHNICAL FIELD

The present invention relates to database systems, and in particular to a database system which configures a database in accordance with a hierarchical tree-like structure which enables fast and comprehensive data querying and output display functions using graphical user interface (GUI).

### BACKGROUND

There are presently very many ways of constructing and maintaining database structures on computer systems. As is well known, the relational database is widely used. In a relational database, every entity in a data model has a number of attributes which may be accorded values selected either from discrete sets of values, or from within ranges of continuously variable values. All entity occurrences having the same attribute types are stored in a relation table, with each entity occurrence occupying a row, or tuple of the table having a field or element corresponding to each attribute. Each field of the row contains an alphanumeric value for the relevant attribute value. Separate tables are provided for different entities each having a different set of attributes.

The data model, or representation of the relationships between the different entities, is provided both implicitly by the incidence of common attributes between the various relation tables, and also by imposing conditions on various attributes such as their identification as key fields.

In extracting data from the database, a query is formulated, in suitable programming language, which instructs the data processing system to scan selected attribute columns of specified tables for adherence to certain conditions, and to output, usually into an output table, the data in preselected attribute columns for each tuple or row of the scanned table or tables. The output table can then be browsed by the user on screen, or printed out.

A number of disadvantages present themselves with this technique. Queries must be formulated using particular query languages which must be learnt by the users. Although these are commonly interfaced with a “natural language” interface making their use easier for the non-expert user, certain rules and protocols must be understood.

The most significant disadvantage is that the queries are quite specific, and do not generally permit what we shall call “progressive querying”: that is to say, once a query has been formulated, the resulting output or results table is produced, and the information contained therein is fixed and limited to the scope of the original query. Further scanning of the output table is possible by formulating a further query to reduce the size of the output by imposing additional limitations on the ranges of values that an attribute may take, for example, but generally, for querying the database, a new query must be formulated each time to scan the appropriate parts of the database. In general, in re-scanning the output table (s) to answer a “sub-query”, the whole of the table or tables must be searched for adherence to the new selection criteria.

In processing a query, it is normally necessary to perform quite complex manipulations on the various tables involved in the query, which include joining or merging operations, and the temporary creation of intermediate tables to be used as the operands for subsequent parts of the query. Such operations naturally involve considerable processing power and time to carry out.

An innovative database management system that offers considerable benefits over the relational database systems referred to above has been described in GB 2293667B and GB 2398143B, the content of which is incorporated herein by way of reference.

### SUMMARY

The present teaching is particularly concerned with techniques for improving the functionality of the database system described in the aforementioned GB patents, particularly in respect of the creation of results tables in response to queries. These results tables are then used for performing progressive querying. The database system of the present teaching allows for an extremely user friendly graphical user interface in which querying and progressive querying can be performed by a user selecting options on presented screens of the graphical user interface.

Accordingly, the present teaching provides a database system which configures a database with a hierarchical tree-like structure. The database can then be queried and the results provided in a results table for further querying or sub querying. By providing a results table which is configured to allow for further querying or sub querying, the present teaching advantageously obviates the need for the entire database to be a scanned each time a sub-query is performed which improves the processing time and reduces the resources required to effect these queries. To achieve such sub-querying the present teaching provides a data architecture which employs a structured database model.

In accordance with a preferred arrangement, a database provided in accordance with the present teaching provides a storage model based on a conceptual data model implementing a hierarchical structure. Every entity, every attribute and every entity occurrence within the database is assigned a unique, multi-character expression which defines the relationship between each entity, attribute and entity occurrence with every other entity, attribute and entity occurrence in the database and may also uniquely define an attribute value to an occurrence of an entity. The expressions are stored in an expression set table linking each element of each expression with a natural language phrase relating the expression to a hierarchical level and a position in a data model. The “expressions” used are multi-character expressions conveniently divided into a number of “words”, each of a number of bytes.

Each multi-character expression indicates a context (in the data model), a specification (e.g. a description/definition of the data being encoded) and a quality (e.g. actual data values or pointers thereto). Where any of these components are unknown or irrelevant, a wildcard character or “non-deterministic” character can be used. A feature of the expressions used to describe the data model is that similar data structures can be replicated throughout the main tree of multi-character expressions by changing only selected characters in the expression. Such an arrangement is similar in structure to that discussed in detail in the patent GB 2293667B, and in subsequent related patent GB 2398143B, and as is clear from the disclosure of these earlier applications, the use of these multi-character expressions to store data in a database offers extremely fast searching and context switching capability when accessing data from the database.

In particular, the present teaching provides a database system and a method of querying a database with a user interface comprising the steps of: scanning at least a portion of the database defining a first group, with a database query expression; generating and displaying, in response to the scanning, a set of results defining at least one sub group; allowing a user to select and store the displayed at least one sub group; and allowing a user to select the stored sub group as a group on which at least one query is to be performed.

### BRIEF DESCRIPTION OF THE FIGURES

The present teaching will now be described by way of example, and with reference to the accompanying drawings in which:

FIG. 1 shows an exemplary data model in accordance with the present teachings;

FIG. 2 shows a plurality of table structures and their inter-relationship which can be used in the implementation of the present teachings;

FIG. 3 shows a results expression table in accordance with the present teaching;

FIG. 4 shows a results entity history table in accordance with the present teaching;

FIG. 5 shows a log in screen of the GUI in accordance with the present teachings;

FIG. 6 shows a screen shot of the report manager feature in accordance with the present teachings;

FIG. 7 shows a screen shot of the group manager feature in accordance with the present teachings;

FIG. 8 shows a screen shot of the group manager feature wherein the user can define the scope of a new group in accordance with the present teachings;

FIG. 9 shows a screen shot of the group manager feature wherein the user can select the descriptive filters of a new group from a dataset in accordance with the present teachings;

FIG. 10 shows a screen shot of the group manager feature wherein the user can choose the descriptive filters of a new group in accordance with the present teachings;

FIG. 11 shows a screen shot of the group manager feature wherein the results of applying the scope and descriptive filters are shown in accordance with the present teachings;

FIG. 12 shows a screen shot of the group manager feature of FIG. 11 wherein a user has selected the “Report on this Group” option in accordance with the present teachings;

FIG. 13 shows a screen shot of the report manager feature wherein the group created with regard to FIGS. 5-12 is selected for reporting on in accordance with the present teachings;

FIG. 14 shows a screen shot of the report manager feature wherein the results of a report run to compare the “length of stay” of two groups is displayed in accordance with the present teachings;

FIG. 15 shows a screen shot of the report manager feature wherein a user is presented with the option to save a portion of the results displayed in FIG. 14 as a sub group in accordance with the present teachings;

FIG. 16 shows a screen shot of the report manager feature wherein a user is presented with text boxes in which the sub group can be named and described in accordance with the present teachings;

FIG. 17 shows a screen shot of the report manager feature wherein a user has chosen to run an “All the answers” report in accordance with the present teachings;

FIG. 18 shows a screen shot of the report manager feature displayed as a result of a user clicking on the “+Select Group” option of FIG. 17 in accordance with the present teachings;

FIG. 19 shows a screen shot of the report manager feature wherein a user has chosen to run an “All the answers” report on the sub group “Emergency admissions stay >4 days” in accordance with the present teachings;

FIG. 20 shows a screen shot of the Group Tracker feature in accordance with the present teachings;

FIG. 21 shows a screen shot of the Group Tracker feature in accordance with the present teachings

FIG. 22 shows a screen shot of the Group Tracker feature in accordance with the present teachings

FIG. 23 shows a screen shot of a time frame selection in creating or defining a group in accordance with the present teachings;

FIG. 24 shows the application of the time frame selection in creating a report in accordance with the present teachings.

FIG. 25 shows a screen shot of the first page of the report manager feature in accordance with the present teachings.

FIG. 26 shows a screen shot of user selectable options that allow the user to select criteria used to create a report in accordance with the present teachings.

FIG. 27 shows a screen shot of further user selectable options that allow the user to select criteria used to create a report in accordance with the present teachings.

FIG. 28 shows a screen shot of user selectable options to define a time frame in accordance with the present teachings.

### DESCRIPTION OF EXAMPLE ASPECTS/EMBODIMENTS

In a system provided in accordance with the present teaching, the physical model, i.e. the storage model which represents the physical structure of the data stored on the computer system is designed to be much closer to a conceptual model of the real world, i.e. the data model of the organisation(s) using the database. This closeness is normally difficult to achieve, simply because the requirements of the computer-accessed disks and other storage media are so different from the human view of the organisational structure being represented by the database. A database implementation which can simplify the interface between the physical model and the conceptual model offers huge advantages in terms of the speed of processing when accessing information from the database, and also greatly simplifies the software and hardware interface necessary to achieve this interface.

In a system provided in accordance with the present teaching, every entity, every attribute and every occurrence of every entity in the data model is uniquely specified by a multi-character “expression” which may conveniently (for the sake of clarity of explanation) be divided into a number of “words”. As illustrated hereinafter, the “expression” may comprise three five-byte words, with each byte representing one ASCII character selected from a set of approximately 200. The number of “words”, however, is not critical to the invention and merely imposes a convenient semantic structure to the expressions as they relate to the data model.

It will be understood that the number of bytes representing a character in the expression, or the length of the overall expression, can be varied according to the requirements of a particular system. In a presently preferred embodiment, the multi-character expression is formed from twenty two-byte characters or “elements”, so that each element may represent any one of 65536 possible different characters.

The expressions do more than simply provide a unique label to each entity, each attribute and each occurrence of each entity, but also implicitly encode the data model by reference to its hierarchical structure and protocol. This is achieved by use of the strict hierarchical protocol in the assignment of expressions to each entity. This can be achieved automatically by the database management system when the user is initially setting up the database, or preferably is imposed by a higher authority to enable the database structure to conform to wider standards thereby ensuring compatibility with other users of similar database systems.

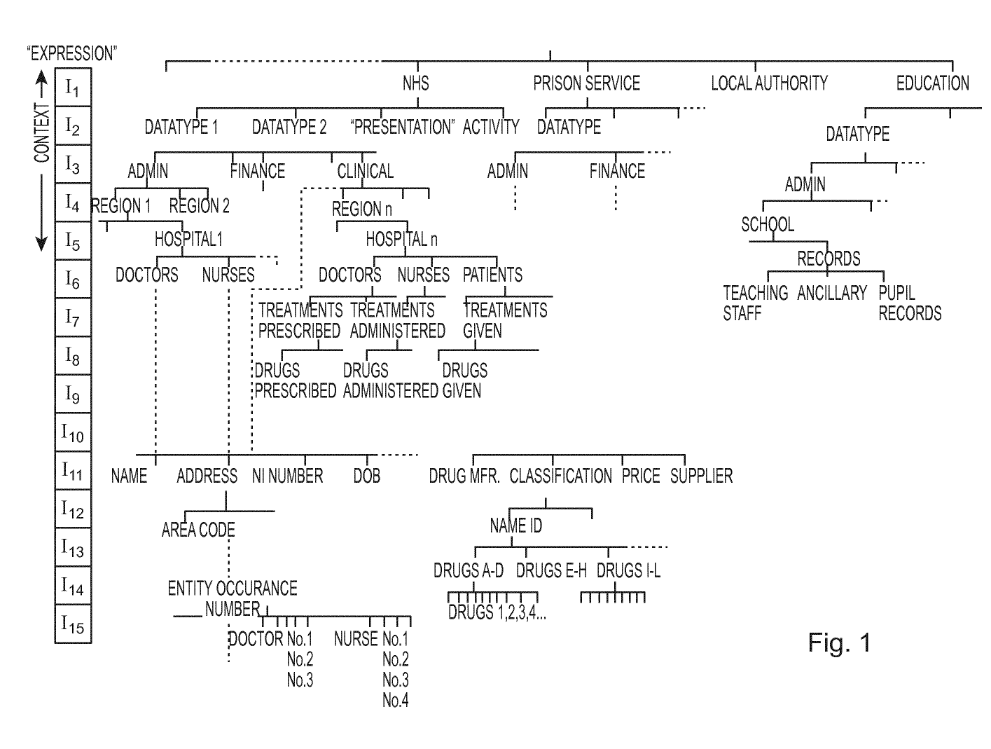

The way in which the database structure is imposed by the assignment of these expressions is best described with reference to an exemplary data model as shown in FIG. 1.

The tree structure in FIG. 1 represents the “known universe” of the data model. Each hierarchical level of the data model is shown horizontally across the tree structure, and each one of these hierarchical levels may be represented by an appropriate byte I₁, to I₁₅ of the expression shown vertically on the left hand side of the drawing. At the highest level of the tree 11, we have context information defining the organisation using the data, for example Health Service, Prison Service, Local Authority, Educational Establishment etc.

The significance of byte I₂ is discussed in aforementioned GB 2293697B and GB 2398143B in more detail, but broadly speaking indicates a data type from a plurality of possible data types that might be used.

Within each organisation (e.g. the Health Service) there may typically be a number of departments or functions or data view types (represented by byte I₃) such as administration, finance/accounts and clinical staff, all of whom have different data requirements. These different data requirements encompass:
a) different data structures or models pertaining to different organisational hierarchies within the department;
b) different views of the same entities and occurrences of entities; and
c) the same or different views of “standard format” data relating to different occurrences of similar or identical entities or attributes.

The significance of this to a system provided in accordance with the present teaching will become clear as one progresses downward through the hierarchy.

Each department may wish to segregate activities (e.g. for the purpose of data collection and analysis) to various regional parts of the organisation: e.g. a geographically administered area or a sub-department. This can be reflected in the structure of the second database 102 by expression byte I₄. Each geographically administered area may further be characterized by a number of individual unit types, such as: (i) hospitals, health centres etc. in the case of an a health service application; (ii) schools or higher education institutions in the case of an education application; (iii) prisons and remand centres in the case of the prison service application.

Each of the organisations and units above will have different data structure requirements (as in (a) above) reflecting different entities, attributes and entity relationships within the organisation and these are provided for by suitable allocation of codes within the I₆ to I₁₀ range of expression bytes. In this case, the same alphanumeric codes in bytes I₆ to I₁₀ will have different meaning when in a branch of the tree under for example a structure such as that provided by the National Health Service (NHS) in the UK, than when under, e.g. the education branch, even though they exist at the same hierarchical level. As an example, the sub-tree structure represented by particular values of bytes I₆ to I₁₀ may refer to patient treatment records in the NHS context, whereas those values of codes may refer to pupil academic records in the education context.

However, in the case of (b) above, where the organisational unit requires the same or different views of the same entities, attributes and occurrences of entities as other organisational units, the codes in bytes I₆ to I₁₀ of one branch of the tree will represent the same underlying structure and have the same meaning as corresponding byte values under another branch of the tree. An example of this is where both the administration departments and the finance departments require a view of the personal details of the staff in the hospital, both doctors and nurses. Note that the views of the data may be the same or different for each department, because the view specification is inferred from the higher level I₁ to I₅ fields. In this case, for entities, attributes and occurrences of entities which are the same in each sub-branch, some or all of the codes I₁ to I₅ which identify each entity occurrence will have identical values.

In the case of (c) above, i.e. the same or different views of standard format data relating to different occurrences of similar or identical entities and their attributes, it will be understood that a number of predefined bytes require the same specification regardless of the particular organisation using them. For example, a sub-tree relating to personnel records, and including a standard format data structure for recording personnel names, addresses, National Insurance numbers, sex, date of birth, nationality etc. can be replicated for each branch of the tree in which it is required. For example, all of the organisations in the tree will probably require such an employee data sub-tree, and thus by use of standardised codes in bytes I₆ to I₁₀ such organisational sub-trees are effectively copied into different parts of the tree. However, in this case, the context information in fields I₁ to I₁₅ will indicate that within each organisation, we are actually dealing with different occurrences of similar format data.

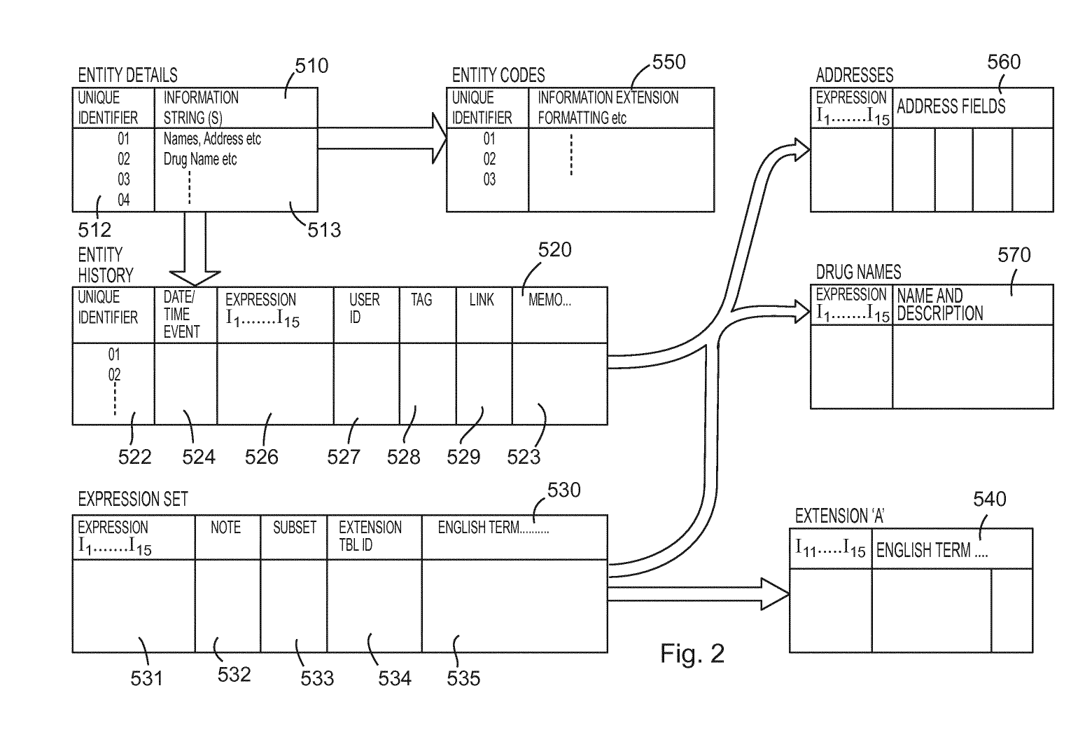

The tree structure defined by the expressions I₁ to I₁₅ can be used to define not only all entity types, all entity attribute types and all entity occurrences, but can also be used to encode the actual attribute values of each entity occurrence where such values are limited to a discrete number of possible values. For example, in the sub-tree relating to treatments in the hospital context, “drug” is an entity which has a relation with or is an attribute of, for example: doctors (from the point of view of treatments prescribed); patients (from the point of view of treatments given); administration (from the point of view of maintaining stocks of drugs) and so on. The entire set of drugs used can be provided for with an expression to identify each drug. In an illustrative embodiment, the parts of the expression specific to the occurrences of each drug will be located in the I₁ to I₁₅ fields as shown in FIG. 2. Thus when used in conjunction with the appropriate fields I₁ to I₁₀ it will be apparent whether the specified drug is in the context of a treatment prescribed by a doctor, a treatment received by a patient, or a stock to be held in the hospital pharmacy.

Further bytes in the expression, lower in the hierarchy can be associated with the drug to describe, for example, quantities or standard prescription types. It will be apparent whether the expression refers to a prescribed quantity or a stock quantity by reference to the context information found higher in the hierarchy. In practice, the number of discrete values allowed for each of these grouped “entity values” using the five fields I₁ to I₁₅ is approximately 200⁵=32×10¹¹. The number of permutations allowed can actually be expanded indefinitely, but in practice this has not been found to be necessary. It is noted, however, that the described model of FIG. 2 merely illustrates a principle of the data model. In an alternatively preferred embodiment, twenty-character expressions are used and the semantic significance of specific fields therein (I₁ to I₂₀) may differ significantly from those presently described in connection with FIG. 2. For example, in the alternative preferred model, “entity values” can occupy each of the two-byte elements I₁₃ to I₂₀, thereby allowing 65536⁸ discrete values (=3.4×10₃₈).

Thus, in the fifteen character expression I₁ to I₁₅, each character represents a natural language expression (e.g., English language expression) defining some aspect of the data model, and by travelling downward through the table it is possible to compose a collection of natural language expressions which represents the complete specification of an entity, an attribute or an entity occurrence.

An overview of the use of an expression set together with the implementing tables which comprise an illustrative embodiment of the database system of the present invention is now described with reference to FIG. 2.

Every occurrence of an entity about which information must be stored is recorded in the entity details table 510. Each occurrence of each entity is given a unique identifier 512 which is assigned to that entity occurrence, and information about the entity is stored as a value expression information string 513. Examples of value expressions are the character strings giving names, street addresses, town, county, country etc., or drug name, manufacturer's product code etc. These details are essentially alphanumeric strings which themselves contain no further useful hierarchical information and are treated solely as character strings. As will become apparent later, the decision as to which occurrence values are handled at this level is determined by the user's requirements. For example, an address may be recorded entirely as character strings having no further hierarchical significance. Alternatively, the county or city field, or postcode portion of an address might usefully be encoded into an expression in order that rapid searching and sorting of, for example, geographical distribution of patients becomes possible.

Attributes which may only take permitted discrete values from a set of possible values may be effectively recorded in the expression I₁ to I₁₅ associated therewith as will be described later.

The unique identifier 512 of each entity occurrence in the entity details table 510 provides a link to an entity history table 520 where entry of, or update to the entity occurrence status is stored. In this table, the event updating the database is given a date and/or time 524, an expression 526, and the unique identifier 522 to which the record pertains, and may include other information such as the user ID 527 of the person making the change.

In the entity history table 520, various details of the event being recorded may not be available, or may have no relevance at that time. For example, a new patient in a designated hospital may be admitted, and some details put on record, but the patient is not assigned to any particular doctor or ward until a later time. Additionally, some information may be recorded which is completely independent of the user view or other context information. Thus the event is logged with only relevant bytes of the expression encoded. Bytes for which the information is not known, or which are irrelevant to the event are non-deterministic and are filled with the wild card character, “#”.

The entity history table 520 may also include an event tag field 528 which can be used in conjunction with a corresponding field in an episode management table to be described hereinafter. It will indicate which coding activity was being carried out when the expression was assigned to the entity. For example, this tag could indicate whether the coding was carried out during an initial assessment, an update, a correction, a re-assessment, etc. This tag also orders entity codes into event groups. For example, in the medical context, when a person enters the system as a patient, they initiate an admission. An episode can have many spells, (such as a period of treatment on ward A, followed by a period on Ward B) and a spell can consist of many events (such as contacts with the attending physician, procedures, tests). What is more, a patient can be involved with more than one episode at a time (for example out-patient episodes with different hospitals pertaining to different illnesses), and under each episode, more than one spell at a time (e.g. involvement with more than one department of each hospital, each dealing with different aspects of each illness). Many organisations need to store this sort of information for costing and auditing purposes. By coding this information into an expression, it will be possible to browse or query this information.

The entity history table may also include a link field 529 which is designated to link related groups of codes allocated during a particular entity-event-times. For example, in a social services application, a home visit, a visit date, miles traveled and the visitor could all have an expression associated with the visit event. The link field will link these expressions together. Alternatively, the event tag field may also cater for this function.

A memo field 523 may also be included in the entity history table to allow the user to enter a free text memorandum of any length for each code allocated to an entity. In effect, every time a field is filled, a memo can be added.

The expression set of the entire database is recorded in a third table, the expression set table 530. This encodes each expression against its natural language meaning, and effectively records the data model as defined by the hierarchical structure of FIG. 2. There is a natural language meaning for each byte of the expression, each byte representing a node position in the data model tree, and the precise significance of every occurrence of every entity or attribute is provided by concatenating all natural language meanings for each byte of the expression: e.g. and again in the context of the NHS in the United Kingdom, —Presentation Data Type—Administrator's View—Region 1—HospitalNo2—Doctor Record—Name—DoctorID1.

As has been discussed previously, the expressions may include expression extensions which map a sub-tree onto the main tree. The expressions may include expression extensions which map a sub-tree onto the main tree as are discussed in more detail in the aforementioned GB 2293697B and GB 2398143B. For convenience, these extension expressions can be located within the expression set table 530 (the extension entries being identified by the byte I₁, or could be located in a supplementary table (not shown), in which the pointer fields I₁₁ to I₁₅ of the main expression are used as the first fields I₁ to I₅ of the extension expression.

The entity history table 520 and the expression set table 530 may each include an extra field holding a version code. In the entity history table, this would indicate a version number of the expression in use at the time the record was created; in the expression set table, expressions may be varied over time according to the version code given. This allows the structure of the hierarchy to change over time without necessarily introducing new expressions. This assists in maintaining backward compatibility of recorded data.

Further details of the tables and their structures will be discussed hereinafter. In use, the database management system first constructs the data model tree structure in the expression set table 530, with each expression being allocated a corresponding natural language term. This can be done by dialogue with the user, or by systems analysis by an expert. Preferably, pre-formatted codes representing certain data structures are used or useable by many different users. For example, personnel file type structures may be used by many different organisations. This allows compatibility of databases to allow data sharing between organisations, with users being allocated blocks of codes for their own user-specific purposes, as well as using shared codes which have already been defined by a higher authority.

In constructing the table, for implementation reasons discussed later, it is highly desirable that the table is maintained in strict alphanumeric order of expressions, with discontinuities between higher and lower tree branches filled in with blank specification lines. It will be understood that these correspond to particular levels within the tree structure for which there are no divisions of branches.

Additional fields may be included in the expression set table. For example, a note flag field 532 may be used to signify that explanatory information is available for a term. This would typically provide a pointer to a notes table. A symbol in this field could indicate the existence of, for example, passive notes (information available on request); advisory notes (displayed when the code is used); and selection notes (displayed to the user instead of the natural language term). A sub-set field 533 may also be provided for expression maintenance tasks, but these are not discussed further here.

When an expression set table has been constructed, it can be related to individual entity occurrences in the following manner. As previously discussed, the unique occurrences of entities can be placed in the entity details table 510, each having a unique identifier 512. This is linked to the expression set table, and thus to the tree via the entity history table. This records the entity unique identifier 512 in a column 522 and links this with the appropriate expression or part expression 526. The date of the event is logged in field 524, and other details may be provided—e.g. whether the data entry is a first registration of a record, whether it is a response record (e.g. updating the database) etc.

Other tables may be used beyond those described in connection with FIG. 2, or the tables structured differently. In one embodiment, the expression set in table 530 is used to identify entities and attributes of entities, together with individual occurrences of entities that do not change over time. Details of occurrences of entities that are transient to the data model may be recorded in a separate table, such as the entity history table 520. Such transient objects may be, for example, individual personnel whose existence in the data model is impermanent or whose function (place) within the data model may change over time (e.g. by promotion of staff or transfer within the organisation). In this instance, the unique identifier 522 and date/time field 524 relative to the expression field 526 indicate the function of that entity occurrence at that time.

The entity ID table 550 (FIG. 2) is an example of a secondary table which is used when communicating and sharing data with other systems. This table matches the entity unique identifier ID codes with entity ID codes used by other systems.

It is also possible to record static entity details in a form which is structured ready for input and output. For example, name, address and telephone records may be stored in successive columns of an address table 560, each record cross-referenced to the main data structure by the expression code or cross-referenced to an entity by the expression code I₁ to I₁₅. The link can thus be made with either the expression set table 530 or the entity history table 520. Then, whenever that branch of the tree is accessed pertaining to one individual record, the full static and demographic details of that entity occurrence may be accessed from a single table.

A similar arrangement is shown for providing detailed drug information, by drug table 570.

A further modification may be made to the embodiments described above in respect of the use of the entity details table 510. It is not essential for all information about an entity occurrence to reside in the entity details table 510.

In some models, it is advantageous to restrict the use of the entity details table 510 to that of a “major entity” only-the most significant entity forming part of the modelled organisation. For example, in the hospital environment, the patient could be chosen as the major entity. In this case, all other (non-structural, character-string) information about entities can be located in an appropriate field of either the entity history table 520, or the expression set table 530. In the case of the entity history table 520, an appropriate field to use is the memo field 523, and in the case of the expression set table 530, an appropriate field to use is the natural language term field 535. It will thus be understood that, where the non-structural information held about even the major entity is small, the entity details table 510 can be dispensed with all together.

A system provided in accordance with the present teaching offers significant advantages in the execution of database querying functions as hereinafter described.

To answer a given query, the database system defines a query expression comprising fifteen bytes (I₁ to I₁₅) which correspond with the expressions as stored in the entity history table 520 and expression set table 530. The query expression will include a number of deterministic bytes and a number of non-deterministic bytes. The non-deterministic bytes are effectively defined as the wild-card character “#”—“matches anything”. The deterministic bytes are defined by the query parameters.

For example, a simple query might be: “How many patients are presently registered at hospital X”. To answer this query, the query expression imposes deterministic characters in fields I₁, (=NHS), I₄ (=hospital identity), I₆ (=patients). Other context information may be imposed by placing deterministic characters in bytes I₂ (=presentation information). All other bytes are non-deterministic and are set to “#”. The database scans through the expression set table matching the deterministic characters and ignoring others. It should be noted that in the preferred embodiment, the expression set table is maintained in strict alphanumeric sequence and thus very rapid homing in on the correct portions of the database table is provided where high-order bytes are specified. This will normally be the case, since the hierarchical nature of the expression set will be arranged to reflect the needs of the organisation from which the data was retrieved. The database system can then readily identify all the expressions of the expression set table providing a match to the query expression.

A significant advantage of the database structure will now become evident. The answer to the initial query has effectively homed in on one or more discrete portions of the expression set table and counted the number of tuples matching the query expression. Supposing that the user now requires to “progressively query” by stipulating additional conditions: “How many of those patients are being prescribed drug Y” requires only the substitution of the non-deterministic character “#” with the appropriate character in the requisite field In of the expression to change the result. Similarly, carrying out statistical analysis of other parameters, such as: “How many patients were treated by doctor Z with drug Y” can rapidly be assessed. It should be understood that progressively narrowing the query will eventually result in all bytes of the query expression becoming deterministic and yielding no match, or yielding a single patient entity match whose details can then be determined by reference to the entity details table 510 (or the appropriate memo field).

It should now be clear that a key to the speed of result of the statistical querying function is the construction of the expression set table 530. When imposing conditions on various attributes of an entity, i.e. by setting a deterministic character in a byte of the query expression, the relevant data will be found in portions of the table in blocks corresponding to that character. Progressive querying requires only scanning portions of the table already identified by the previously query. Preferably these portions are placed in a results expression table as explained in more detail below. Even where a higher level context switch takes place, relevant parts of the expression set table can be accessed rapidly as they appear in blocks which are sequenced by the expression hierarchy. Scanning the expression set table can be achieved most efficiently by recognising that only the highest order, deterministic byte of the query expression need be compared with corresponding bytes of each record in the expression set table until a first match is obtained. Thereafter, the next highest order byte must be included, and so on until all deterministic bytes are compared. This efficient scanning can be achieved by maintaining a strict alphanumeric ordering to the table.

When the database system has scanned and extracted all of the records of the expression set table 530 matching the query expression, it creates a results table and saves the records of the expression set table for further or progressive querying. For example, the results table for the query “How many patients are presently registered at hospital X” can then be analysed to identify how many of the patients are being prescribed drug Y. It can be seen that a results expression set table created in response to the initial query actually contains all of the information relevant to a given patient's treatment at that time, and not just the answer to the initial query “How many patients are presently registered at hospital X”? This is achieved by maintaining the same structure for the results expression set table as for the main expression set table 530. It will be appreciated that if the user wants to perform the query “How many of the patients are being prescribed drug Y?” on the created results expression set table 330 can be done without recourse to any further searching or scanning operation on the main expression set table 530 thereby saving processing time and resources.

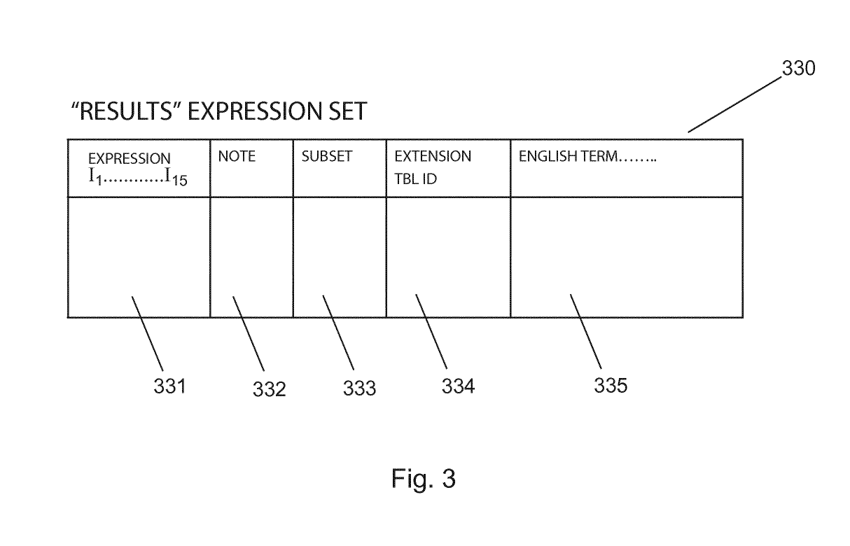

The “results” expression set table 330 has generally the same structure as expression set table 530 is can be clearly seen from FIG. 3. Therefore, a repetition of the description of the structure of this table 330 is not made.

It can be appreciated that the use of a results table such as expression set table 330 is advantageous in that scanning a smaller table is faster than scanning the entire database again. Furthermore, a user can be sure that the results in this table are applicable to the filters without the need to recheck them (so in the event of exploring the data from another direction, additional checks are not required).

A second type of querying relates to examining the historical aspects of the database through the use of entity history table 520. For example, the query may be, “In the last year, what drugs and quantities have been prescribed by doctor X”? To answer this query, the query expression is formulated in the same manner as before with regard to the expression set table 530, imposing deterministic bytes in the appropriate places in the query expression. This will include one or more “lowest order” bytes in I₁₁ to I₁₅ which actually identify a doctor, and non-deterministic characters against the drug fields. This time, however, the entity history table 520 (as opposed to the expression set table 530) is scanned, in a similar manner, seeking only matches of deterministic characters. In a preferred embodiment, the entity history table 520 will be maintained in chronological sequence and thus the search can be limited to a portion of the table where date limitations are known and relevant. Matches of deterministic characters will be found throughout the table where a relevant event relating to prescription of a drug by doctor X is found. Note that the entity history table 520 may include other fields which can be used to impose conditions on the query, such as the user ID of the person entering the record.

In a similar manner as the querying of the expression set table 530 described above, when the database system has extracted all of the records of the entity history table matching the query expression “In the last year, what drugs and quantities have been prescribed by doctor X”?, it saves these to a results entity history table for progressive querying. For example, the results entity history table can then be analysed to identify at which individual hospital the drugs and quantities where prescribed by setting additional conditions on particular bytes of the query expression. Memo fields can be extracted to view comments made at the time of treatment. It can be seen that the results table formed in response to the initial query actually contains all of the information relevant to a given patient's treatment, and not just the answer to the initial query “In the last year, what drugs and quantities have been prescribed by doctor X”?

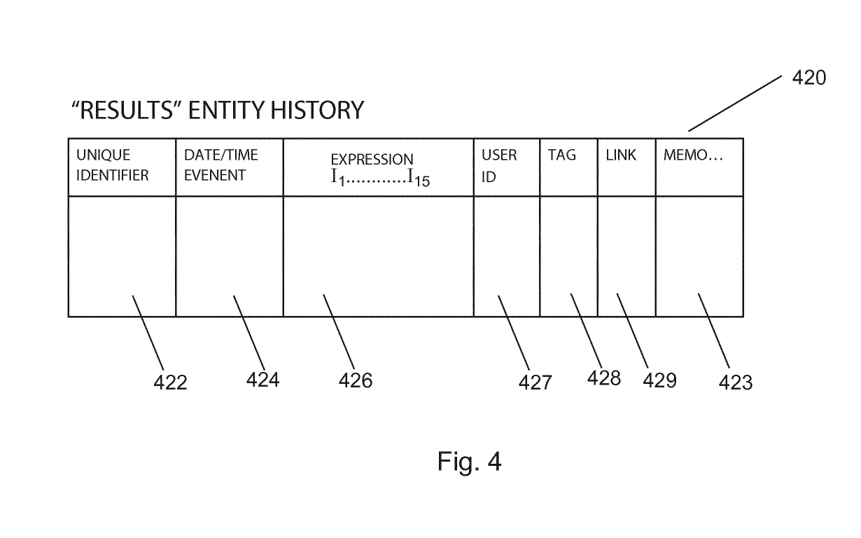

An example of such a results entity history table 420 is shown in FIG. 4. It can be appreciated from FIG. 4 that the structure of this table 420 is the same as that of main entity history table 520 of FIG. 2. Therefore, a repetition of the description of the structure of this table is not made.

A third type of querying relates to analysis of the records pertaining to a single entity value: the entire medical record of patient X. In the preferred embodiment, patient X would be identifiable from the entity details table 510.

The query would initially involve searching for the patient's name to locate the unique identifier (unless that was already known). Once the unique identifier for a patient was known, then the entire entity history table can be scanned very rapidly for any entry including the unique identifier. The strengths of the present invention will then be realized in that the output from this scan will provide a number of entries each of which carries all of the relevant information about that patient incorporated into the extracted expression bytes I₁ to I₁₅. When the database system has extracted all of the records of the entity history table matching the query expression, it saves these to a results entity history table for progressive querying. The entire patient's record, which is now in the results entity history table, can then be progressively queried without recourse to any further searching operation on the main entity history table 520. Specific details of the patient's treatments, doctors, hospital admissions, prescriptions etc. are all very rapidly available at will be assertion of appropriate deterministic bytes in the expression I₁ to I₁₅. For example, the results table can then be analysed to identify which treatments were made at an individual hospital or by an individual doctor by setting additional conditions on particular bytes of the query expression. Memo fields can be extracted to view comments made at the time of treatment. It can be seen that the results table formed in response to the initial query actually contains all of the information relevant to a given patient's treatment.

It is noted that the event history table such as 520 will include many records where the expression stored in the record contains many non-deterministic bytes. For example, where a doctor X prescribes a patient Y with drug Z, other bytes of the expression may be either not known, or not relevant. For example, the patient may have been assigned to a ward W in the hospital which could be identified by another byte. However, this venue in which the treatment took place might be: a) unknown; b) known but not relevant to the record; or c) automatically inferable from the context of the person making the record entry. Whether this information is included in the record is stipulated by the users; however, it will be noted that it does not affect the result of the query whether the byte in the entity history table relating to WARD W is deterministic or non-deterministic, because the query expression will set that relevant byte to non-deterministic unless it is stipulated as part of the query.

It will also be appreciated that any further queries performed on a results expression set table 530 or results entity history table 520 will lead to the creation of more results tables, which only include records that match the further queries. It will also be appreciated that once a results table is queried and a further results table created, the original or first results table can be discarded automatically by the database system. This ensures that excessive memory is not allocated to storing results tables which are no longer of interest to the user. On the other hand a user entering a query can also be provided with an option to save a results table so that this results table can be returned to at a later time for sub-querying. For example, the user may first perform a query “How many patients are presently registered at hospital X” and decide to save the results table created in response to this query. This results table can then be queried with a sub-query and returned to at a later time to perform a different sub-query if the user knows that the sub-query should be performed on result of the original query “How many patients are presently registered at hospital X”.

It should be noted that in the above exemplary embodiments if a query is directed to historical aspects then the scanning is performed on the entity history table 520 but if the query is related to the present such as “How many patients are presently registered at hospital X” then expression set table 530 is scanned. As can be understood from the above, the expression set table 530 is used for referring to the logical “current state” of an entity (e.g., patient) and the entity history table 520 for referring to the logical “history state” of an entity. Although these tables are described above as separate tables, the present teachings are not limited to such a configuration. The inventors of the present application have found that these tables (entity history table 520 and expression set table 530) can easily be merged into a single table, with a flag indicating a “current state” or “history state”. As can be appreciated, any scanning of this merged table will result in a merged results table which has information on both the current state and history state of entities. For ease of understanding, only reference to a results table will be made in the remaining portion of the description. It should be understood that this can refer to results entity history table 320, results expression set table 330 or a merged results table.

It will be understood that there can be many variations on the database used in the above described database system. For example, the database could comprise one or more data elements provided in a flat structure or a relational model. The database could also be provided as a cloud database. These and other variations will be apparent to those skilled in the art.

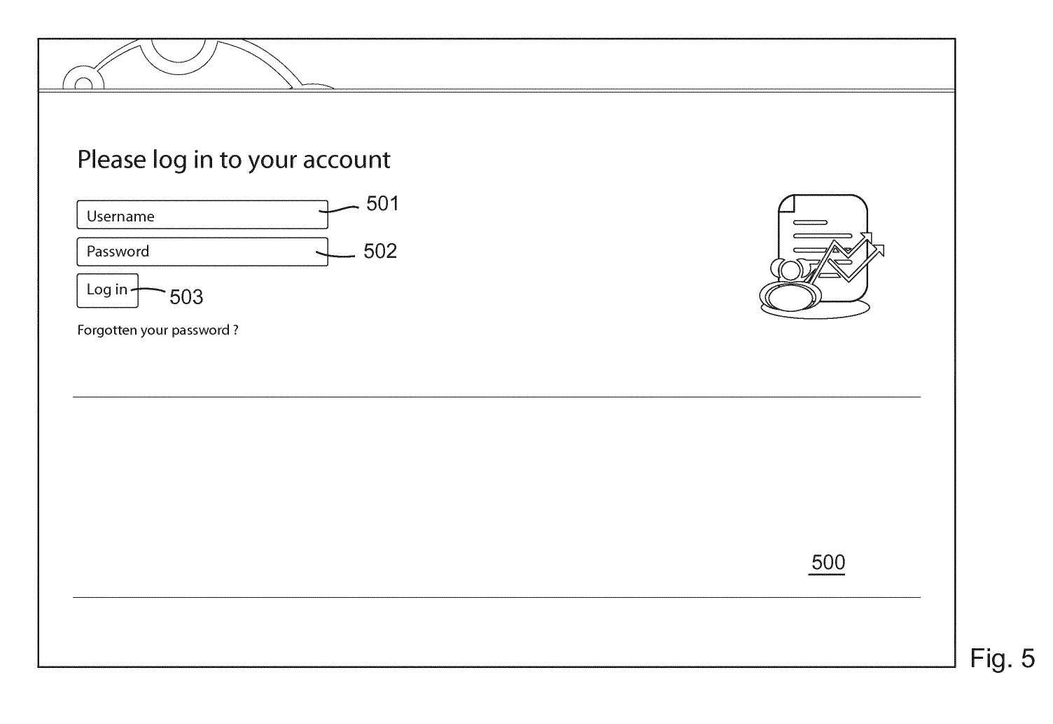

The ability to perform complex queries and sub queries in the previously described database system is best utilised through the use of a graphical user interface (GUI). It will be understood that the present database system provides such a user interface that is useable to create a database query expression for scanning the database. To create the query expression the GUI presents at least one user selectable criterion to a user. This generated database query expression is then used to scan the database system (specifically the expression set table/entity history table or merged table) as outlined above. This use of GUIs to create a database query expression and the subsequent results of scanning the database with this expression is best described with reference to FIGS. 5-13.

FIG. 5 shows a typical login screen 500 presented to a user of the GUI. If a user enters the correct credentials in appropriate edit boxes (user name 501 and password 502 in this case) at the login screen of the GUI then access to the database system is allowed. As is well known to those skilled in the art, “logging in” allows individual access to the computer system to be controlled by identifying and authenticating the user through the credentials presented by the user. Furthermore, as the database system of the subject application is primarily intended for use with medical records of patients, ensuring that access to these records is restricted to only appropriate personnel is of the utmost importance.

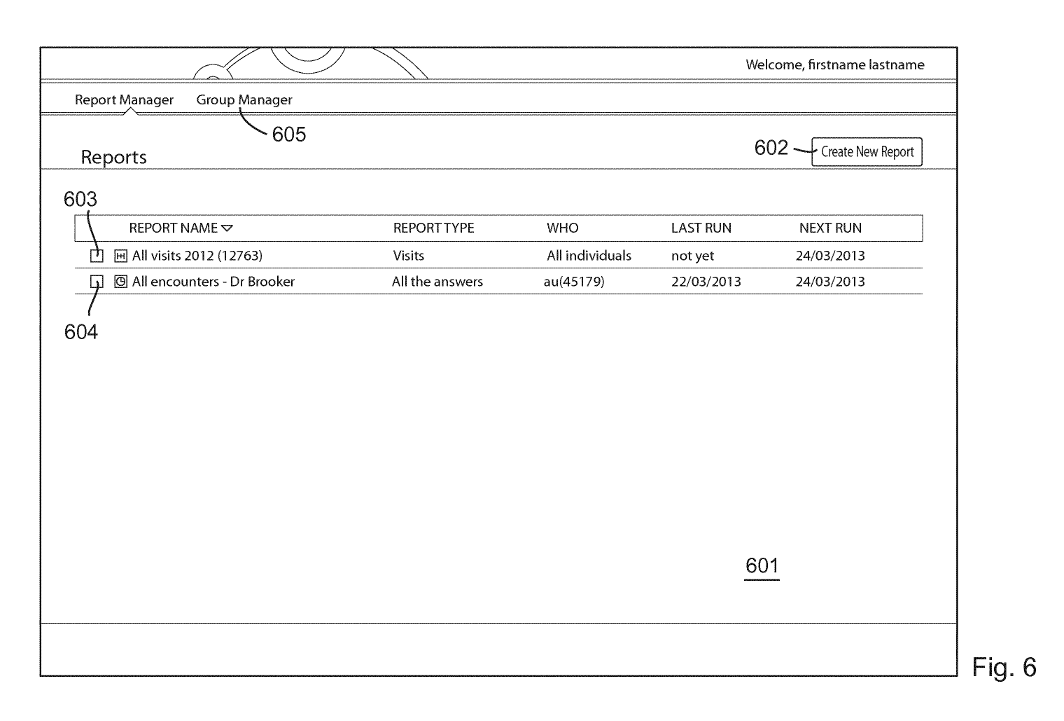

Once the user is allowed access to the database system after clicking the “log in” button 503, the user is presented with a report creation screen 601 such as that shown in FIG. 6. From this screen the user can create new reports (i.e., scan the database using a query expression(s)) by selecting the “Create New Report” icon 602. Alternatively the user can view previously created reports such as the “All Visits 2012” report 603 or the “All encounters—Dr Brooker” report 604. Furthermore, the system can be set up such that these reports are run periodically. As can be appreciated this is quite useful for healthcare practitioners or administrative personnel as it allows regular monitoring/reporting using a specific database query expression corresponding to selected criteria. It will be appreciated from the following explanations and description that although the term “report” is used, the report of the present teaching is quite different to what is conventionally understood in the art.

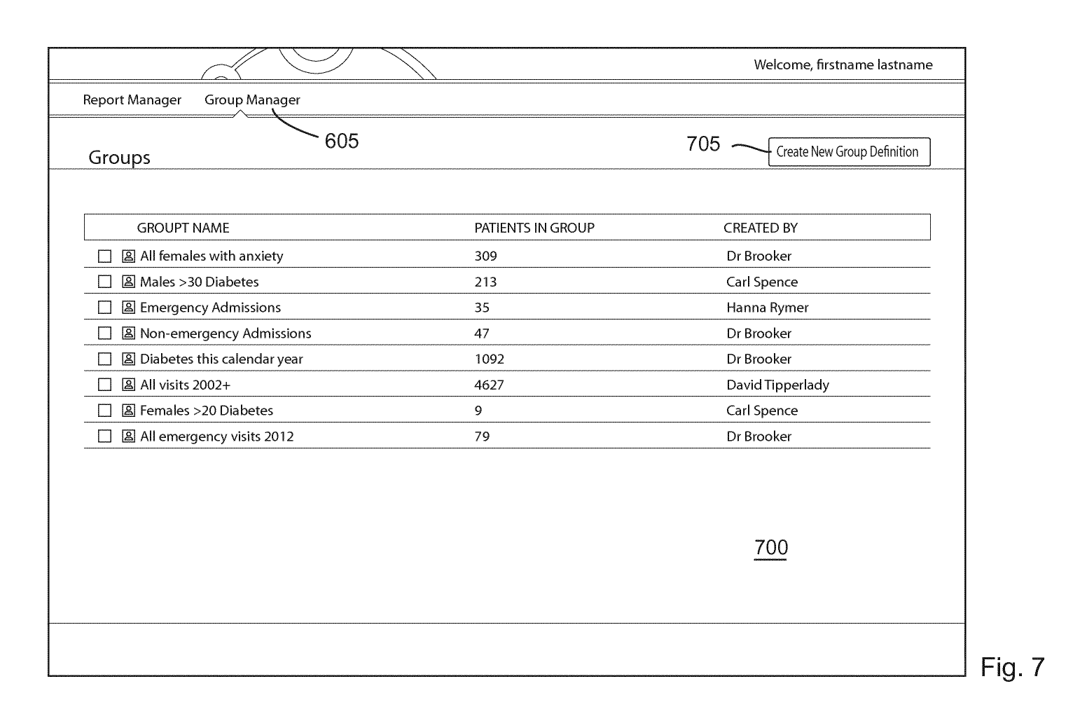

For the purposes of the present example, the use of the group manager is of most relevance. Selection by a user of the “Group Manager” icon 605 at the top of the screen takes the user to the Group Management and Group Creation screen 700 which in this arrangement is accessible from a tabbed screen change feature of the GUI as shown in FIG. 7. In this figure, the user is presented with a plurality (in this example 8) of previously created groups but it should be understood that if a group has not been previously created the list of groups is left blank. In order to create a new group definition (i.e., perform a scan of the database using a database query expression to return specific patients) the user selects the “Create New Group Definition” icon 705 at the top right of the screen.

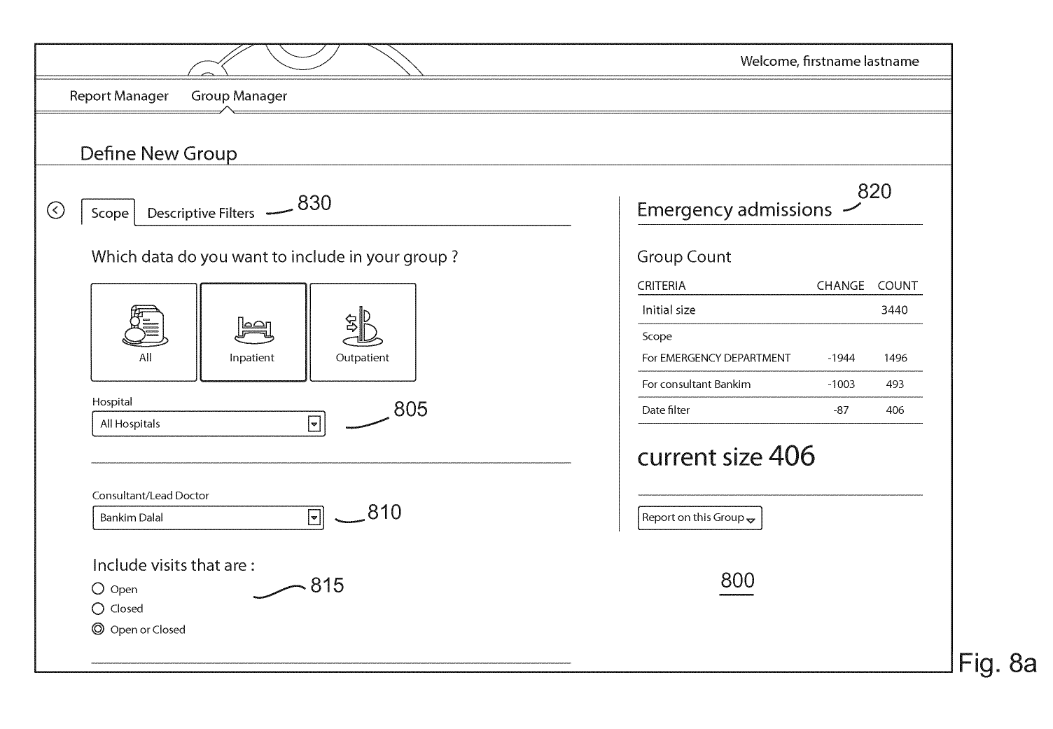

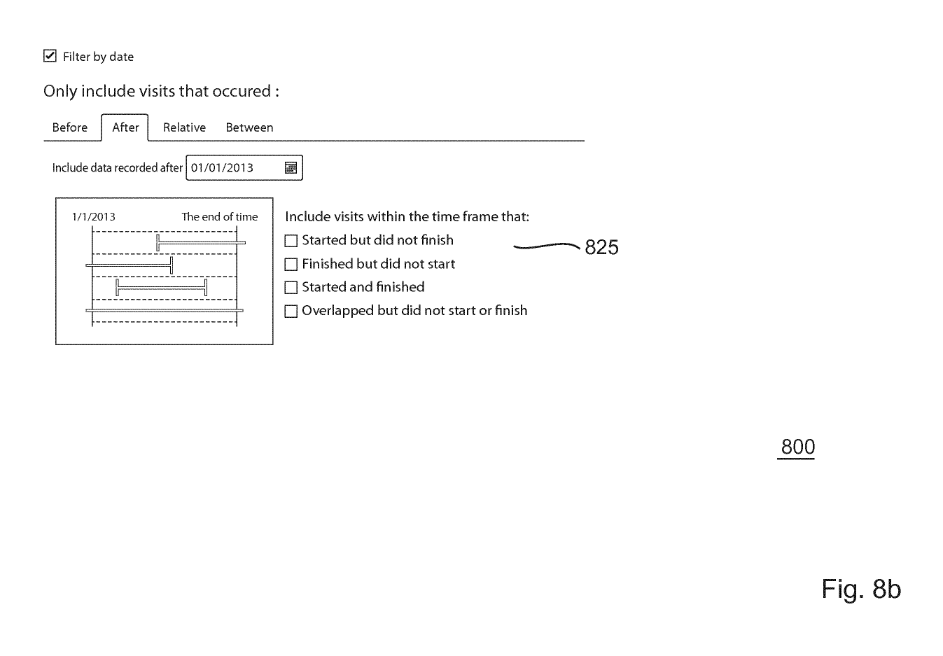

The creation of a new group definition is enabled by a dedicated interface 800 which is generated in response to activation of the “Create New Group Definition” icon 705. An example of how this will look to the user is shown in the screenshots of FIGS. 8a and 8b (these two figures appearing on one screen when presented to a user), in which selection of a plurality of criteria for use in creating the database query expression is made. Specifically a graphical user interface such as that provided by the arrangement of FIG. 8 allows the user to define scope filters 805 to include patients from all hospitals or individual hospitals, a selected doctor or all doctors 810 and a chosen time frame 815. It will be appreciated that the specifics of these scope filters is particular to the example being described and other types of scope filters could be readily defined and used as part of a different application. The scope filters are defined to present a user with displayed user selectable criteria in the form of drop down lists, icons and tick boxes. It should be appreciated that a user does not have to make a selection for each of the criteria or the user may simply be presented with a single criterion such as “Hospital”. As can be well appreciated by those skilled in the art the selection of each criterion is equivalent to setting deterministic/non-deterministic bytes in the database query expression previously described. The significance of the scope filter is that it enables a user to specify relationships between registered entities (in the example given a patient seen by Doctor X at hospital Y).

The new group being created can also be given a name (usually a descriptive name) by the user in the Group Tracker section on the top right of FIG. 8a—in this case, the name “Emergency Admissions” is given to the group being created and will be visible as an icon 820 to the user.

The Group Tracker feature of the GUI is particularly useful and is made possible through the use of the aforementioned results tables. As each criterion is selected or updated, a scan is performed using the created database query expression and the results are stored in a results table. The use of the results table enables visual display to the user of the results so far and thus enables the user to visually identify those portions of the data of particular interest for further investigation. In this way the screen 800 is dynamically updated with information particular to the search query being constructed during the construct of the query. Furthermore, the user may find that the information presented in the Group Tracker is sufficient for their needs at that time and decide that there is no need to run a report in order to get the results of the query as results are presented in an on-going basis. For example in the screen shot of FIG. 8, the user is presented with information that there are 406 elements associated with the consultant Banking in the Emergency department for the time period specified, after the Jan. 1, 2013. The inventors have found that the Group Tracker is best created from an in-memory representation of the results table. Although the Group Tracker can be implemented directly against the results table, in practice using an in-memory representation has led to performance optimisation.

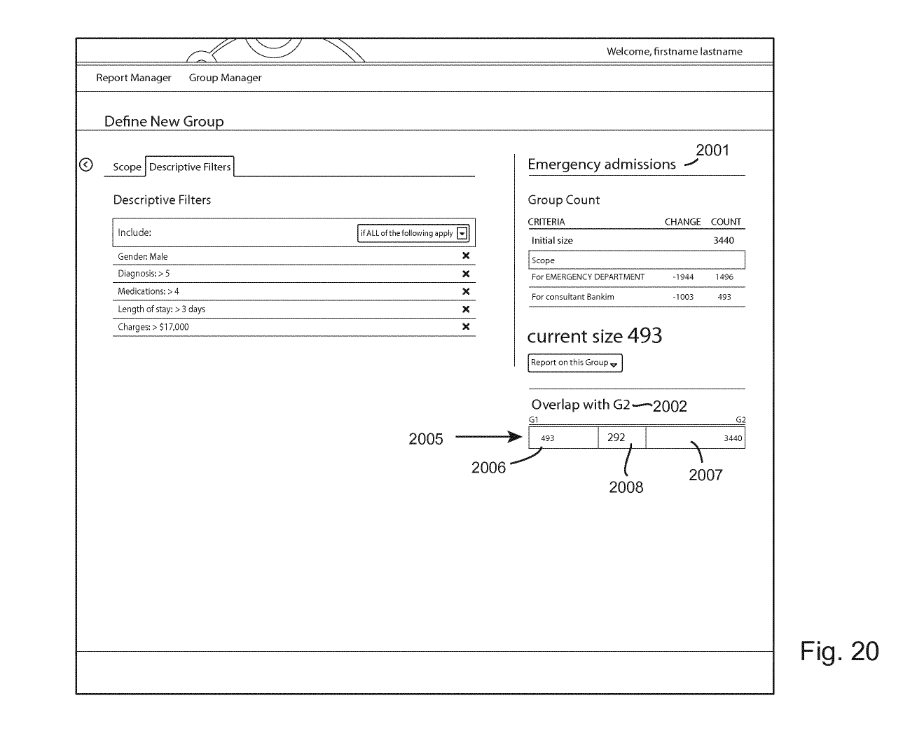

The Group Tracker feature of the present teaching is particularly advantageous and will be described in more detail with reference to FIGS. 20-22.

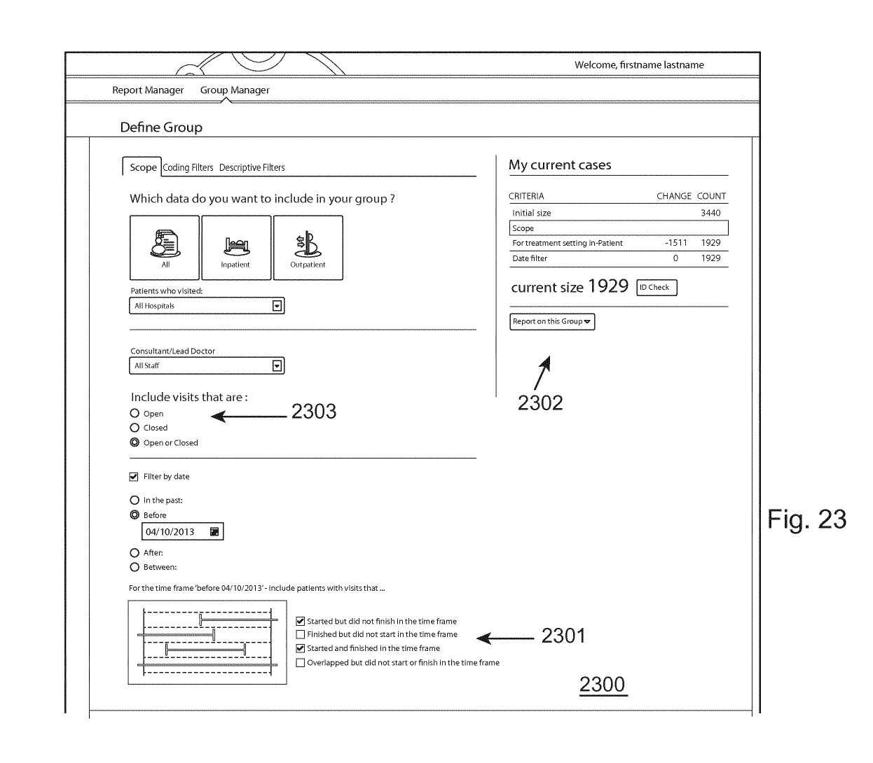

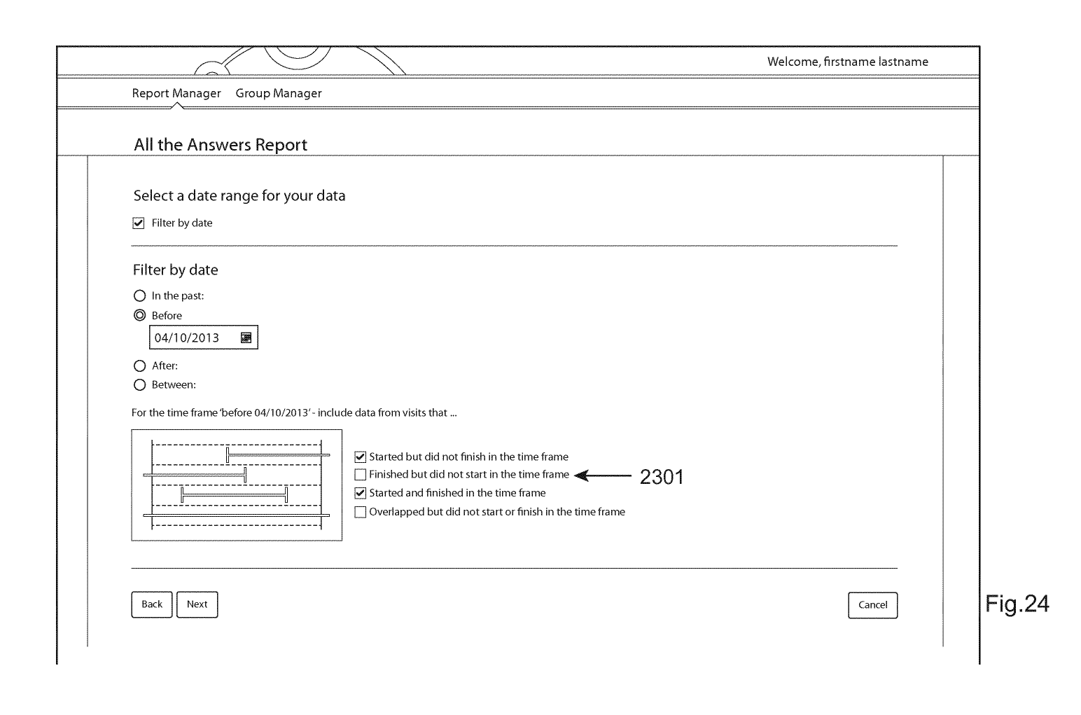

The feature of “Filter by date” as shown in FIG. 8b allows a query to be performed around a specified target time frame or “width of now” ΔT. A plurality of options 825 are presented to the user in the screen of FIG. 8b as indicated by the tabs “Before”, “After”, “Relative” and “Between” wherein the “After” is the tab chosen in the screen of FIG. 8b. Furthermore the filtering by date is not limited to visits that occurred after a certain date but by selecting the tick boxes a plurality of further options are presented to the user such as “Started but did not finish” etc with reference to the selected date (in this case Jan. 1, 2013). Filtering by date in the group manager achieves the effect of identifying ‘all individuals who had the relevant object relationships, events and characteristics within the selected timeframe. This is a particularly useful feature and will be described in more detail with reference to FIGS. 23 and 24.

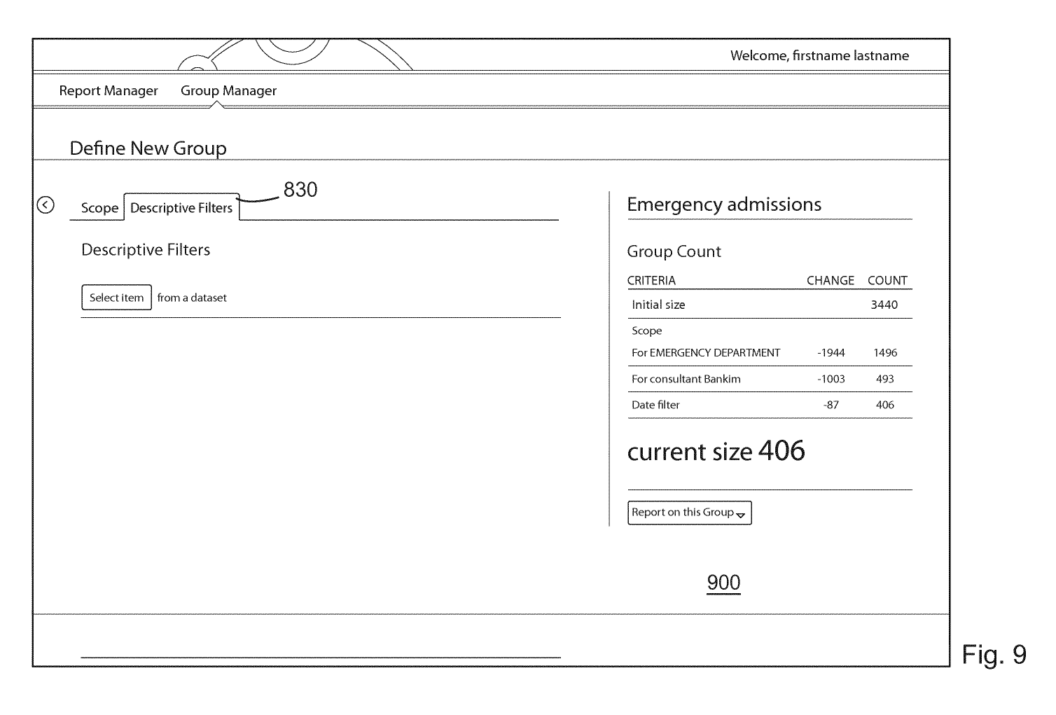

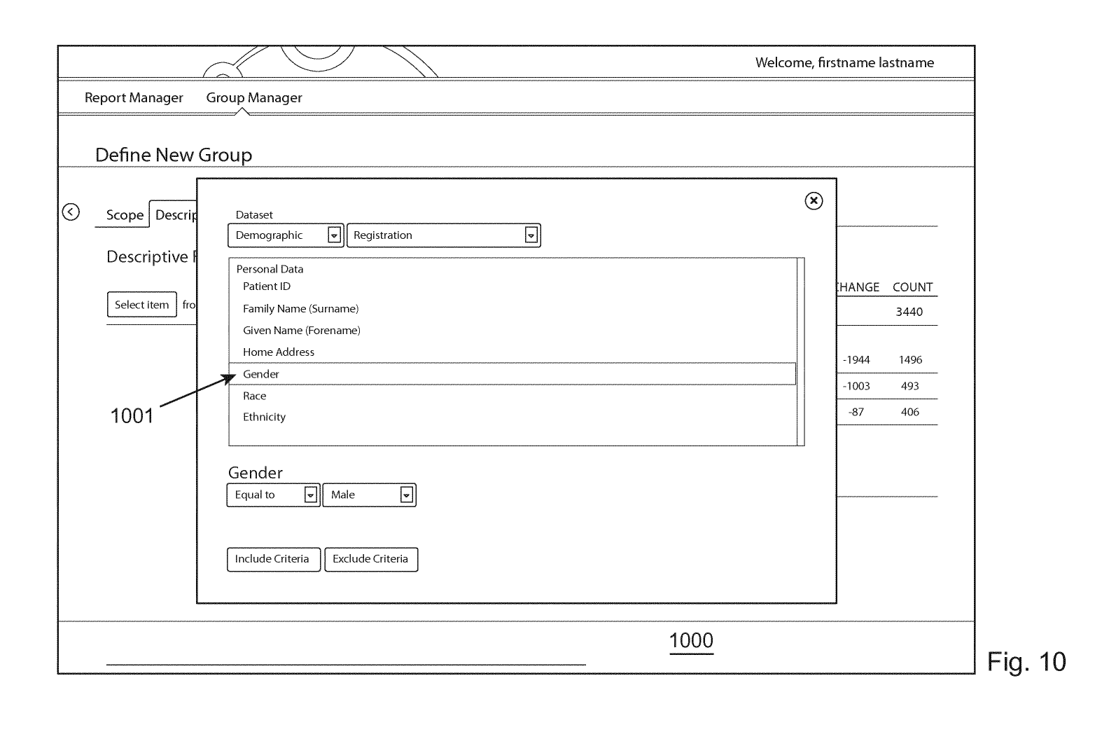

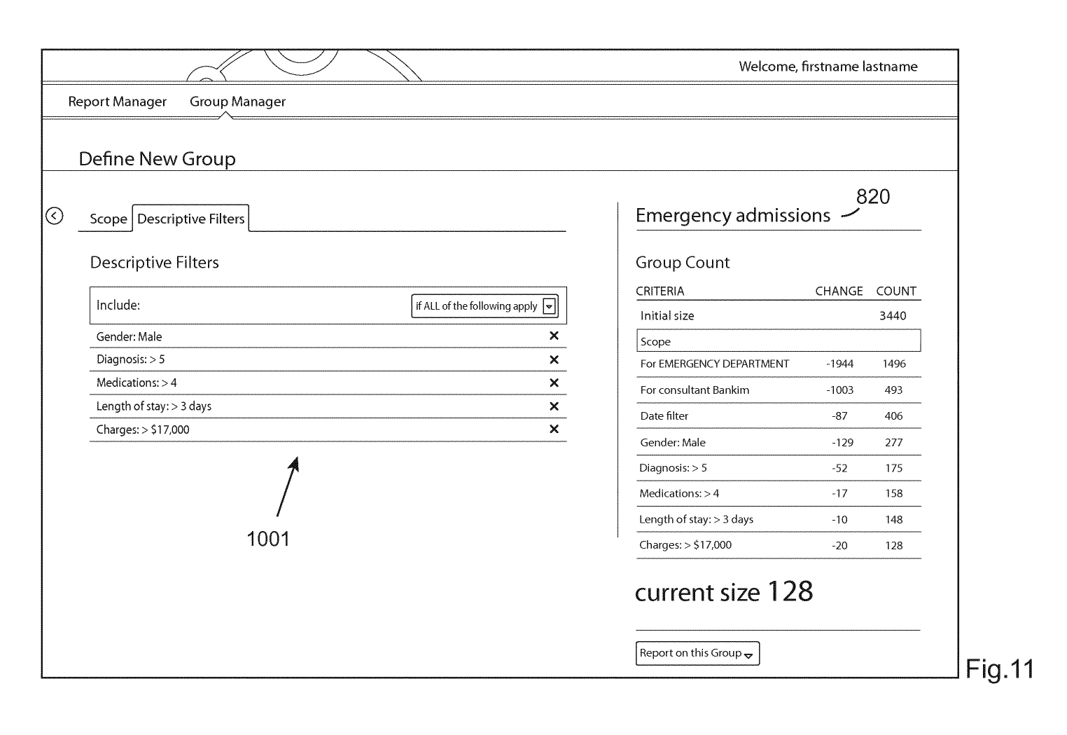

Further criteria can be selected by the user clicking on the “Descriptive Filters” tab 830 of FIG. 8a, which leads to the display such as that shown in the screenshot 900 of FIG. 9. The screen shown in FIG. 9 provides the user with an interface that allows the user to select criteria for the descriptive filters by clicking on the “Select item from a dataset” option, which in turn leads to display such as the screenshot 1000 of FIG. 10 which provides a plurality of user selectable criteria 1001. As illustrated in FIG. 10, a user is allowed to define the gender, diagnoses, medications, length of stay and charges. The previously mentioned scope filters contrasts with these ‘descriptive filters’ as the descriptive filters essentially permit the assignment and searching by attributes of entities such as doctor at hospital shown in FIG. 8 or gender of patient etc. In this way the descriptive filters provide a more granular filter definition than that provided by the scope filters. In the exemplary embodiment shown in the GUIs the attributes are patient attributes but they could equally be hospital or doctor attributes. Furthermore, the criteria 1001 presented in FIG. 10 are merely examples and any of a plurality of other descriptive criteria that would be useful to the user can be added to the GUI for presentation to the user. Again, it will be appreciated that selection of each criterion in FIG. 10 is equivalent to setting deterministic/non-deterministic bytes of the database query expression. Once the user has chosen the desired descriptive filters in FIG. 10, the user can select “Include Criteria” or “Exclude Criteria”. For example, the user can choose to include all genders equal to male or exclude all genders equal to male from the “Emergency Admissions” group. In the presented example, the user selects “Include Criteria” and is presented with the screen of FIG. 11.

FIG. 11 shows the specific descriptive filters chosen by the user in FIG. 10 as well as an updated “Group Tracker” showing each of the descriptive filters applied to the initial size i.e., the initial group and the effect that each criteria has on the initial size. As previously mentioned the user may choose not to run a report on the created group “Emergency admissions” as the number of patients that meet the selected criteria (scope and descriptive filters) is presented in the “Group Tracker” section 820—128 patients in the present example. This example reinforces the benefit of having a dynamically updated results display generated as part of the definition of the query being constructed.

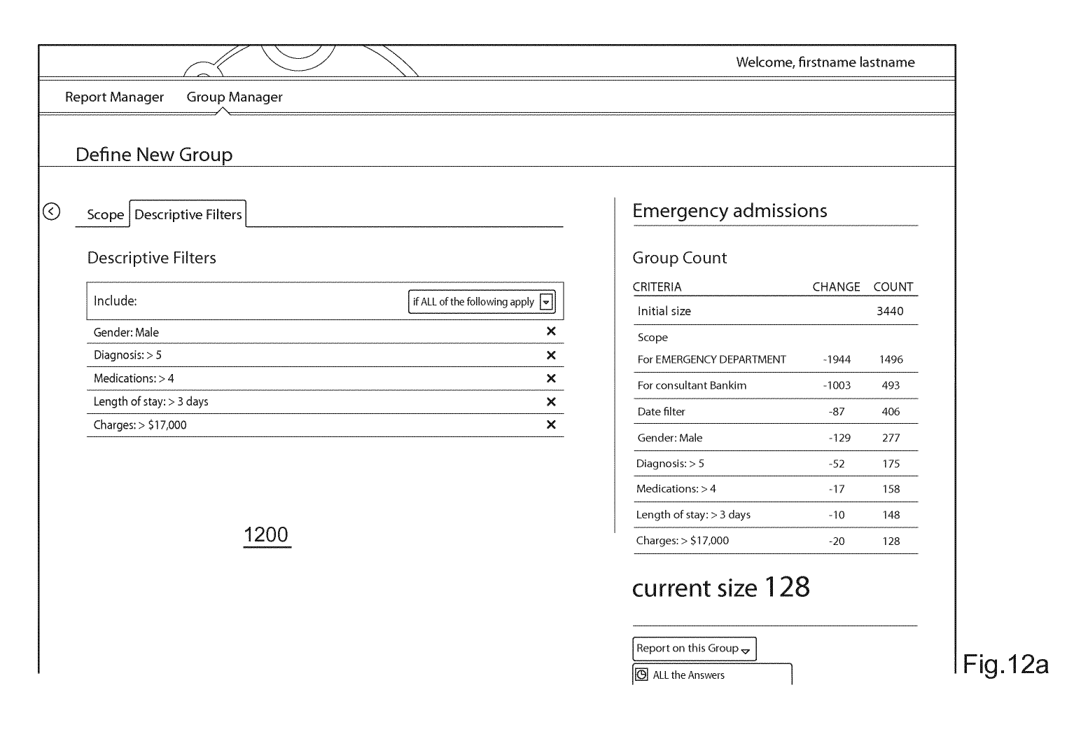

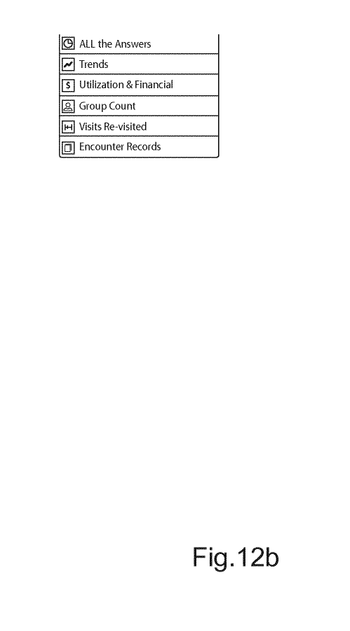

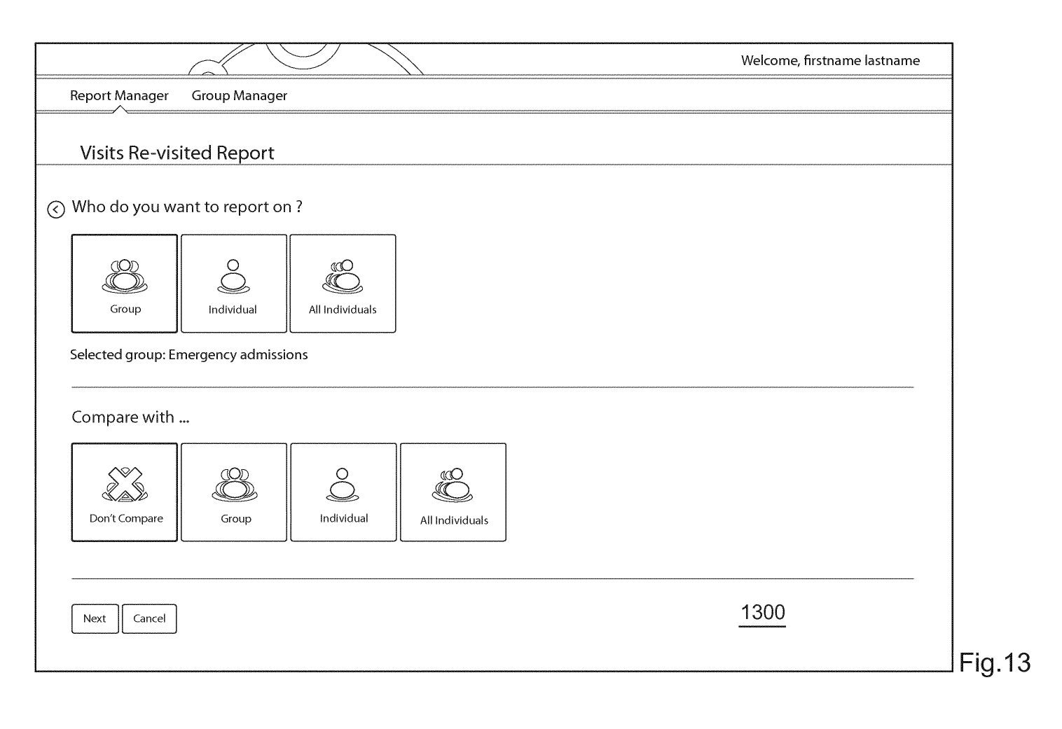

However, if the user wishes to run a report then the “Report on this Group” drop down list is selected and a report type is chosen from the plurality of report types “All the Answers”, “Trends”, “Utilisation & Financial”, “Group Count”, “Visits Re-visited” and “Encounter Records”. This is illustrated in the exemplary screen shot 1200 of a graphical user interface shown in FIGS. 12a and 12b (these two figures conventionally appearing on one screen when presented to a user). In this case the user selects “Visits Re-visited” and is presented with a report manager interface 1300 for reporting on the selected group “Emergency Admissions” as illustrated in FIG. 13. A number of other options such as “Compare with” are also presented to the user in FIG. 13, which allows a user to run a report comparing one group to another.

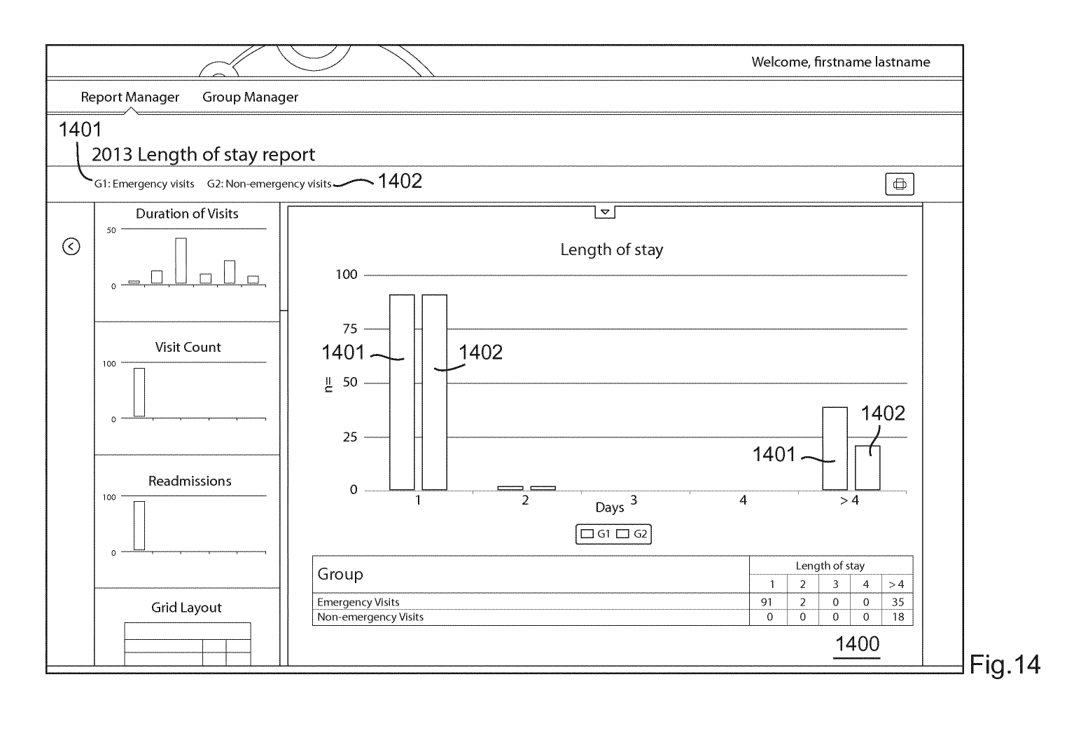

As previously mentioned the use of results tables is particularly useful for presenting the user with the constantly updated “Group Tracker”. However, the use of results table(s) has further advantages. The user can be presented with the opportunity to save a results table, which defines a group such as the “Emergency admissions” group created with reference to FIGS. 5-13. Alternatively, a particular portion of the results table or group may be of particular interest to a user and they may wish to save this portion. This results table or portion thereof is typically saved as a sub group for future querying. This aspect of the present teaching is best described with reference to FIGS. 14-19.

FIG. 14 shows the results of running a report comparing two groups “G1: Emergency visits” and “G2: Non-emergency visits”. For example, the information presented in the screenshot 1400 shown in FIG. 14 could be the result of a user creating an “Emergency visits” group using a similar process as outlined above with regard to FIGS. 5-12 in which the user created the “Emergency admissions” group. Then a report could be run comparing “Emergency visits” with another group, in this case “Non-emergency visits”, using the GUI screen depicted in FIG. 13.

In the example of FIG. 14, a portion of the group Emergency Visits is of particular interest to the user i.e., emergency visits having a length of stay greater than 4 days. This portion or sub group of the Emergency Visits group is created by scanning a portion of the database defining the “G1: Emergency visits” group, with a database query expression or a plurality of database query expressions and in response to the scanning, generating and displaying a set of results defining at least one sub group. The emergency visits having a length of stay greater than 4 days being one of these sub-groups.

The present teaching displays the set of results or sub group by displaying a graphical representation of the set of results i.e., the red group bar 1401 on the >4 days column of the bar chart shown in FIG. 14. This graphical representation is however not a static representation but rather a dynamic interface to the base data that is used to define the graphical representation. A user can simply click the red group bar 1401 on the >4 days column of the bar chart in order to save the 35 patients represented by this column as a new group or sub group of Emergency Visits. It should be appreciated that although the graphic representation of the results is shown in FIG. 14 as a bar chart the graphical representation can be any one of a pie chart, a histogram and a line chart. In this way the present teaching generates a results list that is graphically presented to a user but also retains as part of the graphical display the data that is relevant to that graphical representation to allow a user subsequently store or manipulate that data in a different way.

It should also be noted that although FIG. 14 shows a plurality of results related to two groups G1 and G2 e.g., length of stay equal to one day, length of stay equal to two days etc., the present teaching are not limited to such a configuration. A user could just have easily created a query directed to only one group such as G1 to determine that there are 35 many non-emergency visits with a length of stay >4 days.

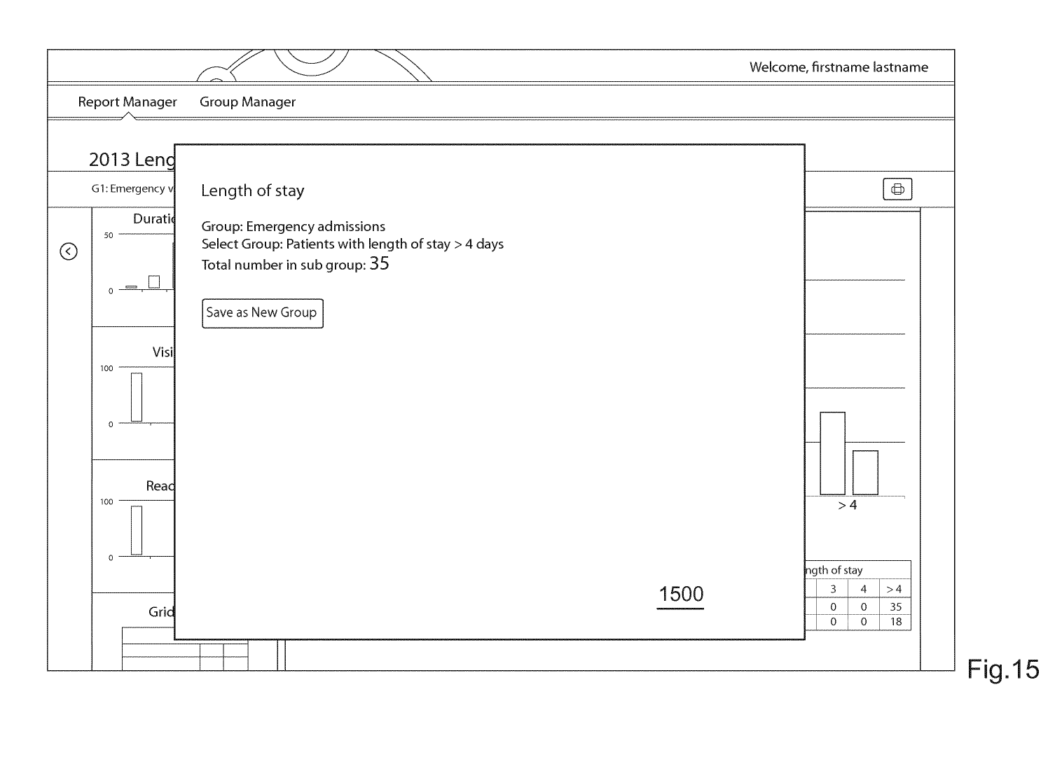

After clicking on the appropriate column of the bar chart (the red group bar 1401 on the >4 days) in FIG. 14, the user is presented with a screen 1500 such as that illustrated in FIG. 15, in which detail of this sub group is described and the user is presented with the option “Save as New Group”. Essentially this allows a user to select and store the displayed sub group. It will be appreciated that although the sub group emergency visits having a length of stay greater than 4 days is selected for storing, any of the sub groups represented by the columns of the bar chart in FIG. 14 can be chosen for storing. As will be further described, a user is allowed to select the stored sub group as a group on which at least one query is to be performed.

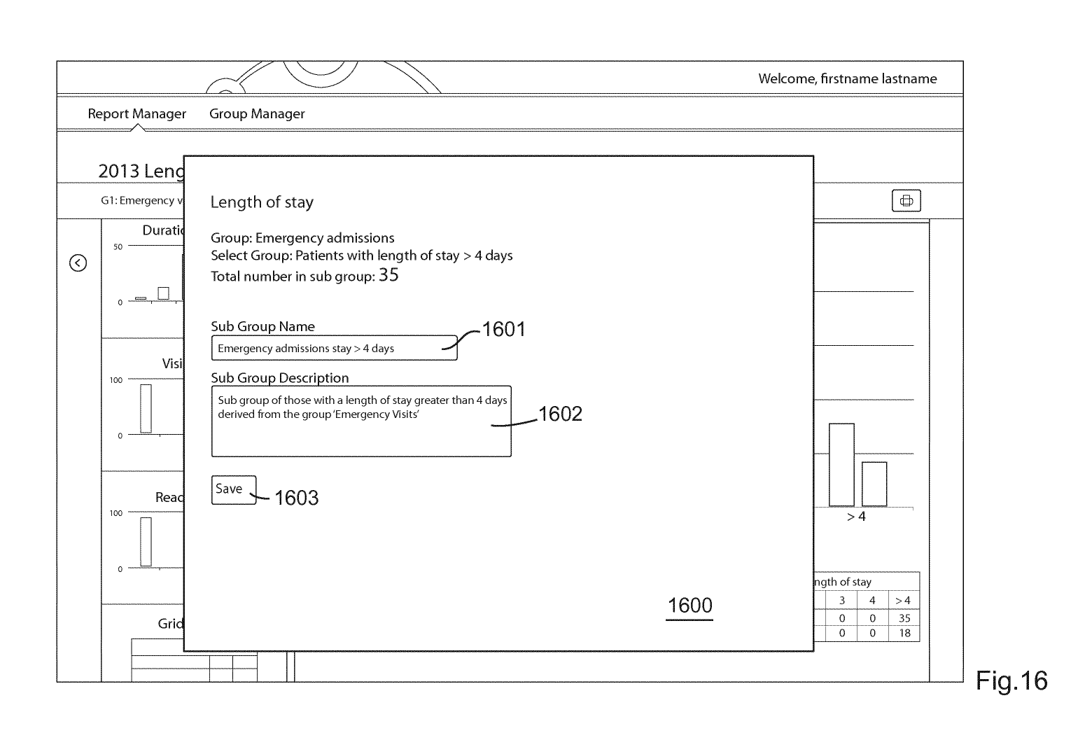

Selection of the “Save as New Group” option leads to the display of a screen 1600 such as shown in FIG. 16, in which the user can name and describe the new sub group in the appropriate user editable text boxes 1601, 1602. After entering text in each text box the user saves the newly created group by clicking on the “Save” icon 1603.

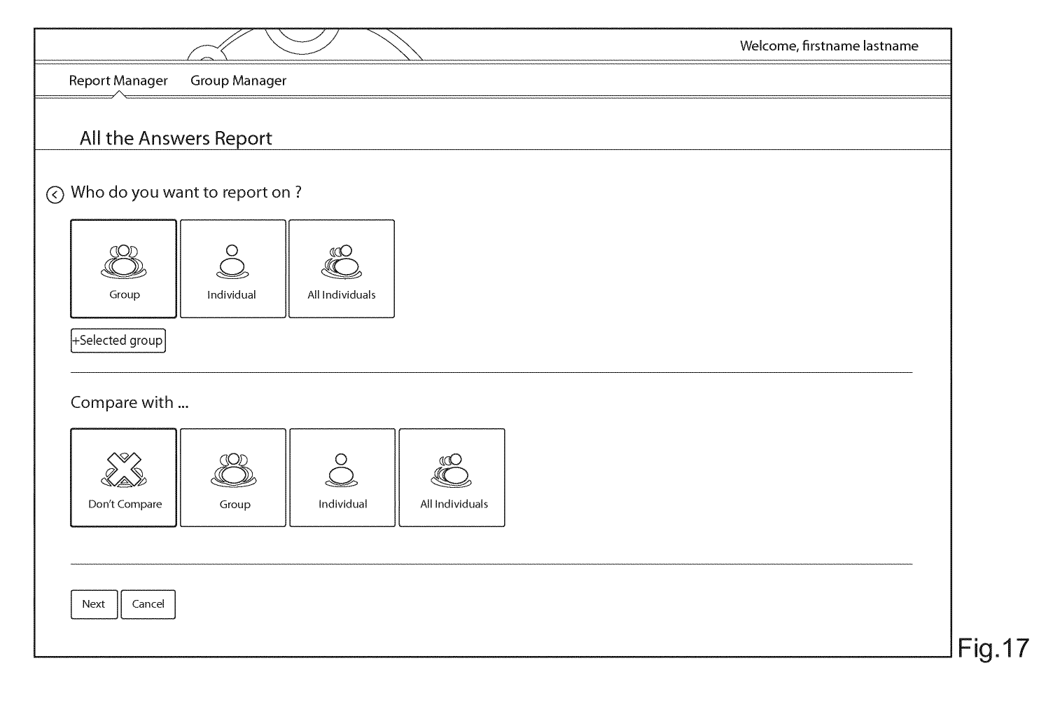

As a result of creating and saving the new sub group “Emergency admissions stay >4 days” in memory, each time a user want to run a report in the Report Manager feature of the present teachings (FIG. 17, which is similar to that described in FIG. 13), the user can select the saved sub group “Emergency admissions stay >4 days”. It will be appreciated that running a report on a group or sub group involves scanning the results table corresponding to the group or sub group with a database query expression created by the user.

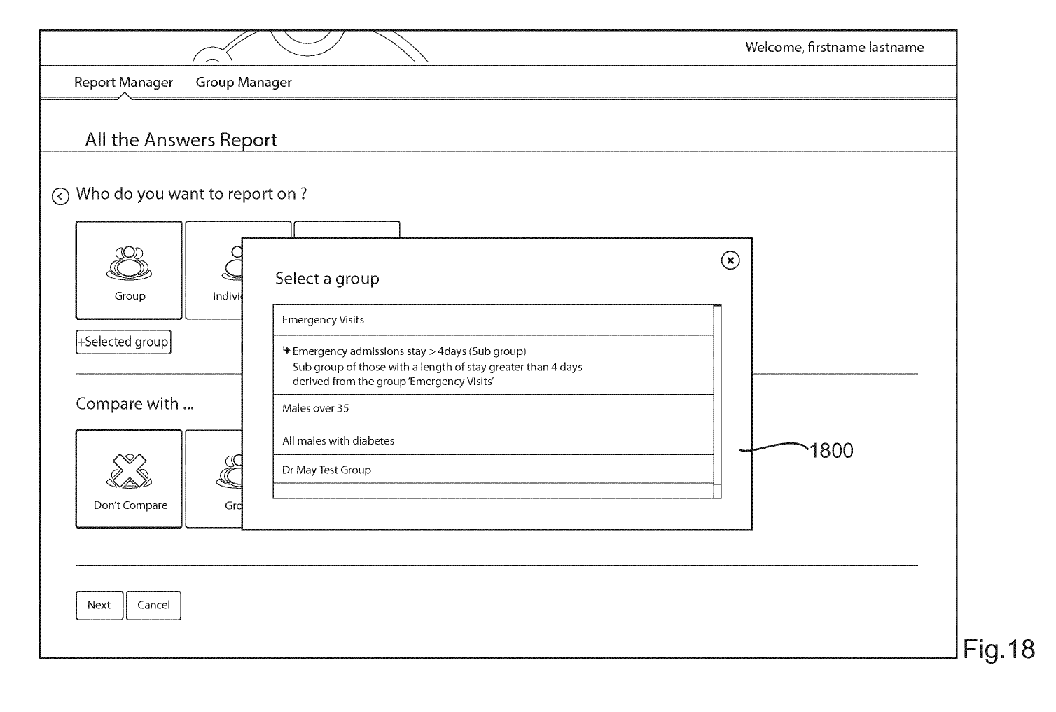

By clicking on the “+Select Group” option in FIG. 17, the user is presented with the screen 1800 of FIG. 18 in which a plurality of groups are displayed such as previously mentioned Emergency Visits. Other groups that have been previously created in this exemplary screen shot include Males over 35, All males with diabetes and these are also presented to the user. Of course if other groups have not been previously created, then only the Emergency Visits group is displayed to the user in FIG. 18. FIG. 18 essentially allows a user to select the stored sub group as a group on which at least one query is to be performed by displaying the stored sub group in a tree structure including the Emergency Visits group. Furthermore, the tree structure is displayed in FIG. 18 including any other previously created groups or sub groups.

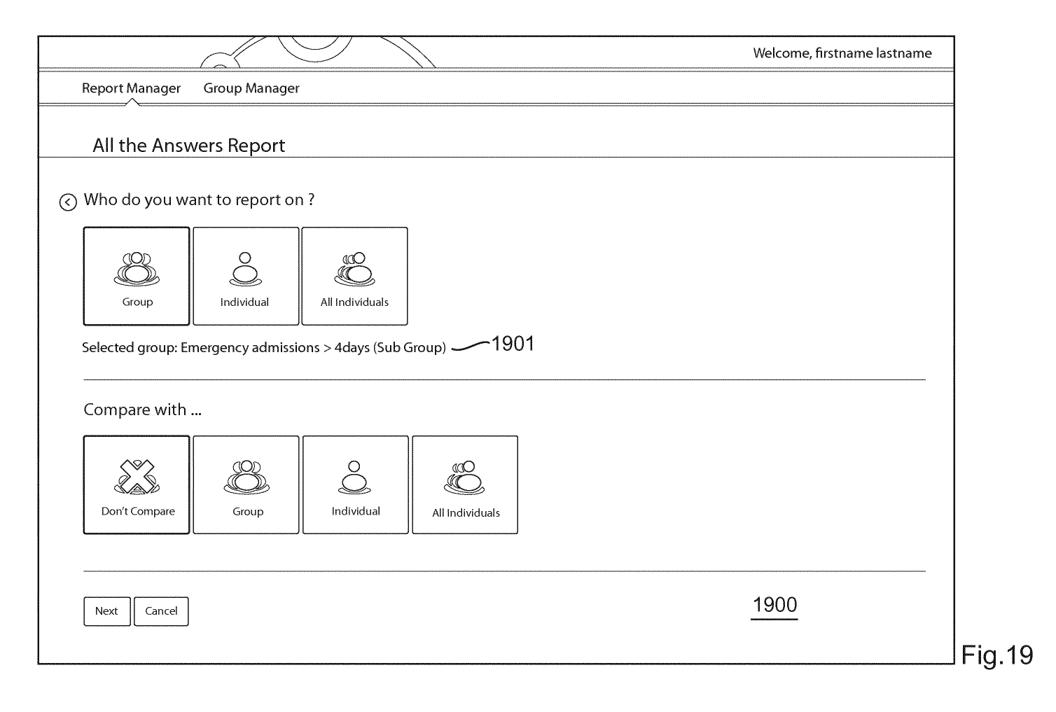

After selection of the sub group “Emergency admissions stay >4 days”, the user is presented with the screen 1900 as depicted in FIG. 19. This screen is similar to FIG. 17 but is now populated with information 1901 that shows “Emergency admissions stay >4 days” as the selected group and also identifies this group as a sub group. In a similar manner as described with reference to FIG. 13 above, the user is presented with the option of comparing the selected group with another group, individual or all individuals. Alternatively the user can choose not to compare the selected sub group “Emergency admissions stay >4 days” with any group or individual and simply run a report on the sub group itself.

As will be appreciated the exemplary embodiment of FIGS. 14-19 is referring to medical patients but the present teachings are not limited to such entities.

The creation of results databases as outlined above allows for the feature of saving a sub group for further querying. By saving a sub group, further queries can home in the required data only without having to re-scan the whole database. Additionally, since the results table will include the IDs of all relevant entities it becomes subsequently possible to select any sub-group of interest from the results at any stage and choose to run literally any further query and then store the results of the query/scanning as a sub group of the scanned sub group. Specifically, a user can scan at least a portion of a database defining the sub group, with a database query expression or a plurality of database queries. In response, a set of results defining at least one further sub group is generated and displayed. A user is allowed to select and store the displayed sub group and further allowed to select the stored further sub group as a group on which at least one query is to be performed. In such a case, FIG. 18 would show a sub group of the sub group “Emergency admissions stay >4 days” in the tree like structure.

A further feature of the present teaching worth noting is the ability to auto-generate new multi-character expressions from combinations of pre-existing expressions. For example, this could be calculating length of stay from the stored expressions for ‘date of admission’ and ‘date of discharge’ and storing the result of this calculation as a multi-character expression in a results table. Although calculated fields are a feature of many databases, the effect of the ability to store the results of the calculation as a multi-character expression is that the user automatically gets to have access to the attribute represented by the result of the calculation for group or report definition purposes, something which would not ordinarily be the case. So, for example, the user could select patients with ‘length of stay >4 days’ for purposes of group definition in the group manager, something which they would not be able to do if the result of the calculation was simply a numeric value. Since the auto-calculation and multi-character expressions are determined solely by the configuration data, logically the user can set up a report on ‘all patients with length of stay >4 days’ prior to any data actually having been entered and hence prior to any actual auto-calculation of lengths of stay having occurred.

As previously mentioned with reference to FIG. 8, the Group Tracker feature of the present teaching is particularly advantageous in that it allows a user to perform querying of a database with a user interface and receive real time feedback. This is achieved by the user interface displaying user selectable criteria and concurrently displaying the results of scanning at least a portion of the database using a database query expression generated using at least one selected criterion of the displayed user selectable criteria. Importantly the displayed results of scanning the database are updated in response to a user selection of at least one further criterion of the user selectable criteria. Furthermore, the updating is done each time a user selection of at least one further criterion is made. This can be appreciated from FIGS. 8-11 i.e., any criterion change in the scope filter or descriptive filter selected by the user will result in a change in the results shown in the Group Tracker (provided of course that not all the results shown in the Group Tracker meet the changed criterion).

It can also be appreciated that updating the displayed results comprising generating a further query using the at least one further criterion and scanning using the further query. Simply put, if a user selects a criterion from the scope filter or descriptive filter then a further scan using a newly generated query must be performed in order to update the results in the Group Tracker. Of course this scanning is done “behind the scenes” and the results in the Group Tracker are updated virtually instantaneously.

It can also be appreciated that scanning using the further query comprises only scanning a portion of the database corresponding to the results of the previous scanning. As previously mentioned, the Group Tracker is maintained by displaying the results in a results table and depending on the criterion selected only the results table corresponding to the Group Tracker needs to be scanned when a displayed criterion is changed by a user.

As can be seen from FIG. 8, displaying the results comprising displaying an “initial size” corresponding to the portion of the database that is initially scanned. It can be understood that the portion of the database that is initially scanned can be (and often is) the entire database. Therefore, the initial size count 3440 shown in FIG. 8 could be all the patients in the database. Alternatively initial size count 3440 could be a portion of all the patients in the database as a result of the application of some pre-filtering not explicitly shown in the figures of the present application. In addition, the user interface displaying the results in the Group Tracker comprising displaying a current size corresponding to the results of the scanning—in FIG. 8a, this is shown as 406 patients.

As is best illustrated with reference to FIG. 11, displaying the results (or current size) comprising displaying each of the at least one selected criterion and the corresponding change to the results caused by selecting each of the at least one selected criterion. As previously mentioned, any change in the criterion such as the selection of at least one criterion results in displaying each of the least one further criterion and the corresponding change to the results caused by selecting each of the at least one further criterion.

As will now be described with reference to FIGS. 20-22 the Group Tracker feature can also display a comparison of the displayed results with stored results of a previous scanning of the database. This displaying of a comparison of the results using comprises displaying a graphical representation of the comparison but as should be understood the present teaching is not limited to such a graphical representation.

As illustrated in FIG. 20, the “Emergency admissions” group 2001 is defined as a first group G1 and compared to a previously created group G2 2002. Specifically, the displayed results (the results of scanning using the criteria of the scope filter and descriptive filters) are defined as a first group G1, the stored results are defined as a second group G2 and system is configured to dynamically generate for the user a graphical representation 2005 which shows in addition to the relative sizes of each of the two originating groups 2006, 2007 any overlap 2008 between these two groups. This graphical representation is shown as a Venn diagram in FIGS. 20-22, specifically a rectangular shaped Venn diagram 2005. The graphical representation used is basically a re-creation of the traditional Venn diagram as a rectangle with 3 sections, the middle one 2008 showing the overlap between the two groups 2006, 2007 and corresponding to the intersection in a conventional Venn diagram. This graphical representation has a number of advantages over the traditional Venn diagram: it is easier to calculate and display proportionate size of each section (because dealing with a rectangle rather than a circle and therefore pi); and it is easier to stack up a plurality of them in a manner that enables multiple comparisons of respective proportions on a single page. The use of a plurality of Venn diagrams stacked in a single display may be used to compare the first group G1 2001 with a plurality of groups stored in memory, not just G2 2002, although only comparison with G2 is shown in the figures. Specifically a plurality of graphical representations (Venn diagrams) can be displayed each showing the overlap between the first group and a respective one of the plurality of other groups.

Although the rectangular Venn diagram is the most advantageous graphical representation, it should be appreciated that the present teachings are not limited to the rectangular shaped Venn diagram 2005 shown in the FIGS. 20-22.

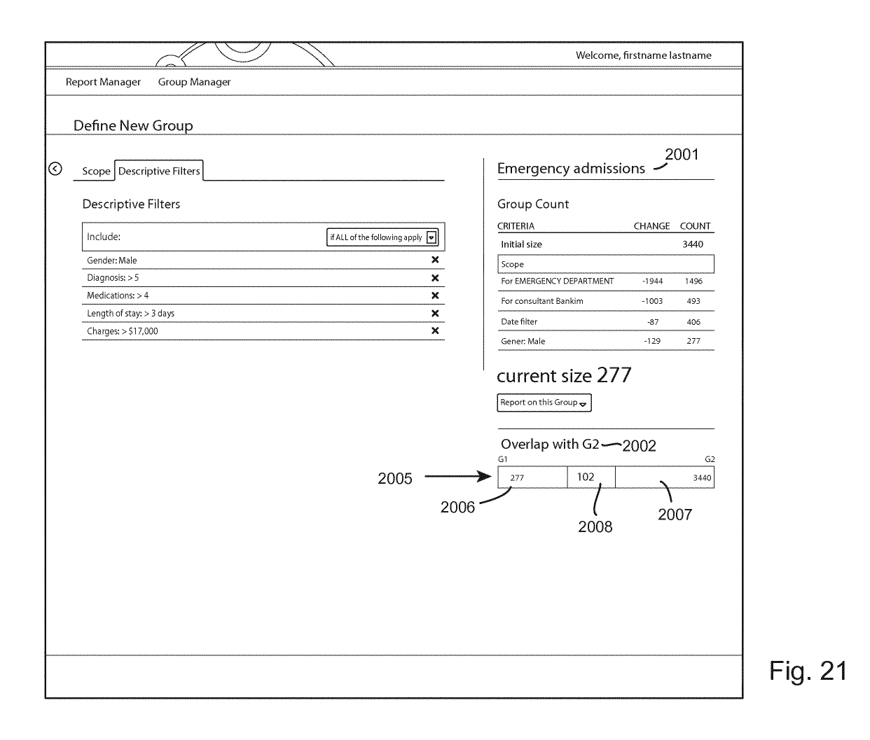

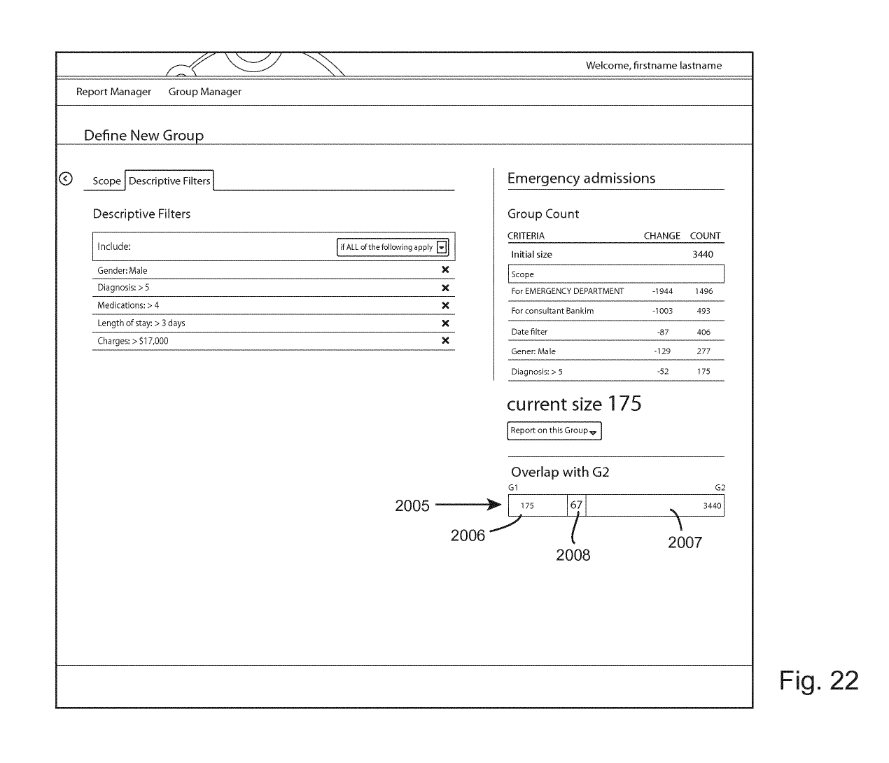

As can be understood with reference to FIGS. 21 and 22, updating the displayed results comprising updating the displayed comparison as well as updating the displayed overlap 2008 between the first group 2006 and the second group 2007. Specifically, as shown from the progression from FIG. 20 to FIG. 21 and then FIG. 22, as more criteria are selected by a user such as date filter, gender etc. the current size 2001 of the Emergency admissions group G1 2006 is reduced and the overlap 2008 with G2 2007 is correspondingly reduced. This is shown in the Venn diagram wherein the overlap 2008 is eventually reduced to 67 patients in FIG. 22.

Another advantageous feature of the Group Tracker and in particular the graphical representation is that any segment of the 3 sections 2006, 2007, 2008 (G1, G2 and overlap) of the ‘Venn diagram’ display 2005 can also be saved as a sub-group in the same way as discussed previously with reference to FIGS. 14 to 19. This allows a user to perform even more complex querying with relative ease: for example, it would be easy for a user to define GROUP A who meet criteria a, b, c, d and e but not f, g, and h, and then to define GROUP B who meet criteria i, j, k but not l and m; and then using the Venn diagram approach to select all members of Group A who do not meet the criteria for group B i.e. all patients for whom (criteria a, b, c, d and e but not f, g, and h)=true but for whom (criteria i,j,k but not l and m)=false. This ability, combined with the basic approach in the group manager of permitting combinations of include and exclude whereby for each set of inclusion or exclusion criteria the user can select the English phrase ‘include/exclude individuals to whom all the following apply’ or ‘include/exclude individuals to whom at least ONE of the following apply’ means that using very simple English language plus these simple ‘Venn’ diagrams users can in effect apply very complex combinations of logical operators without ever having to use anything other than simple English terms and a simple intuitive graphic. In this way a search query may be constructed using a combination of text input and graphically presented data.

As previously mentioned with regard to FIG. 8, the ability to set a ‘time frame’ using the “Filter by date” section of the user interface is particularly useful. The time frame feature can be used when creating a group in the previously mentioned group manager feature of the present teachings and can also be used to create a report in the report manager feature of the present teachings.

Setting the time frame defines the scope of the results, so that selecting Hospital X, Doctor Y and time-frame 2012 means the results for the group or report will be “all patients seen by doctor Y in hospital X in 2012”. Setting a time frame in this way permits a level of control of time boundaries by the user that would not ordinarily be achievable. The problem is that when the scope is set in relation to entities in this manner a statement such as ‘all patients seen by doctor Y in hospital X in 2012’ is multiply ambiguous when it comes to report generation or group creation. For example, does the user wish to include in this group/report all patients who were admitted to hospital prior to 2012 but still seen by doctor Y in 2012? If they do, this would affect the output of certain report types, for example, calculation of length of stay.

In order to address these ambiguities when setting the time frame, the inventors have found that providing a user interface displaying a plurality of user selectable options each defining a time frame boundary for an event(s) is the optimal solution. Each user can then maximise the power of the present database system by setting virtually any time frame suitable for their needs in an unambiguous way.

The ability to set a time range related to events is achieved as a result of the database defining a plurality of events having respective entities associated therewith as has previously been discussed with regard to FIG. 2. When querying the database, by setting a time range for events, only the entities associated with those events that occurred within the time range are included in the results of the queries. As has been previously described examples of entities are patients, hospitals, doctors, drugs etc.

FIG. 23 shows an exemplary screen shot 2300 illustrating use of a date range representation 2301 in defining a group of individuals in a similar manner as FIG. 8. Note that the application of the graphic 2301 at the bottom of this figure is dependent upon the selection of ‘Inpatients’ at the top of the screen. As ‘All inpatients’ has been selected then all patients who have had an inpatient admission within the timeframe as per the settings will be included in the results. Essentially, FIG. 23 displays a user selectable option allowing a user to select an event 2303 as a criterion for querying the database. The event shown in the exemplary embodiment of FIG. 23 is “visit” but there could conceivably be other events displayed in FIG. 3 for selection. Further criteria can also be selected in FIG. 23 such as a specific inpatient hospital, in which case only patients with an inpatient admission to that hospital in the timeframe would have been included in the results.

FIG. 23 also displays in the graphic time window 2301 a plurality of user selectable options each defining a time frame boundary for the event i.e., visit. These exemplary options include “Started by did not finish in the time frame”, “Finished but did not start in the time frame” “Started and finished in the time frame” and “Overlapped but did not start or finish in the time frame”, wherein each option has a tick box beside it and the two tick boxes with ticks are the options selecting for defining the time frame boundaries.

When a user has finished setting the time range, the user can define a group in a similar way to that described above, which essentially involves querying the database by scanning the database for all entities associated with at least one event that has occurred within at least one selected time frame boundary.

Filtering by date in the group manager (as described with reference to FIG. 23) achieves the effect of identifying all individuals who had the relevant object relationships, events and characteristics within the selected timeframe. This contrasts with the further use of the time frame selection described below (with reference to FIG. 24) within report creation where it is used to identify subsets of data pertaining to those individuals within the time frame. As is described, in this way it is possible to set different time frames for individual selection and data selection within a single query. It will also be appreciated that in the same way the database design also enables the setting of more than two time frames within a single query.

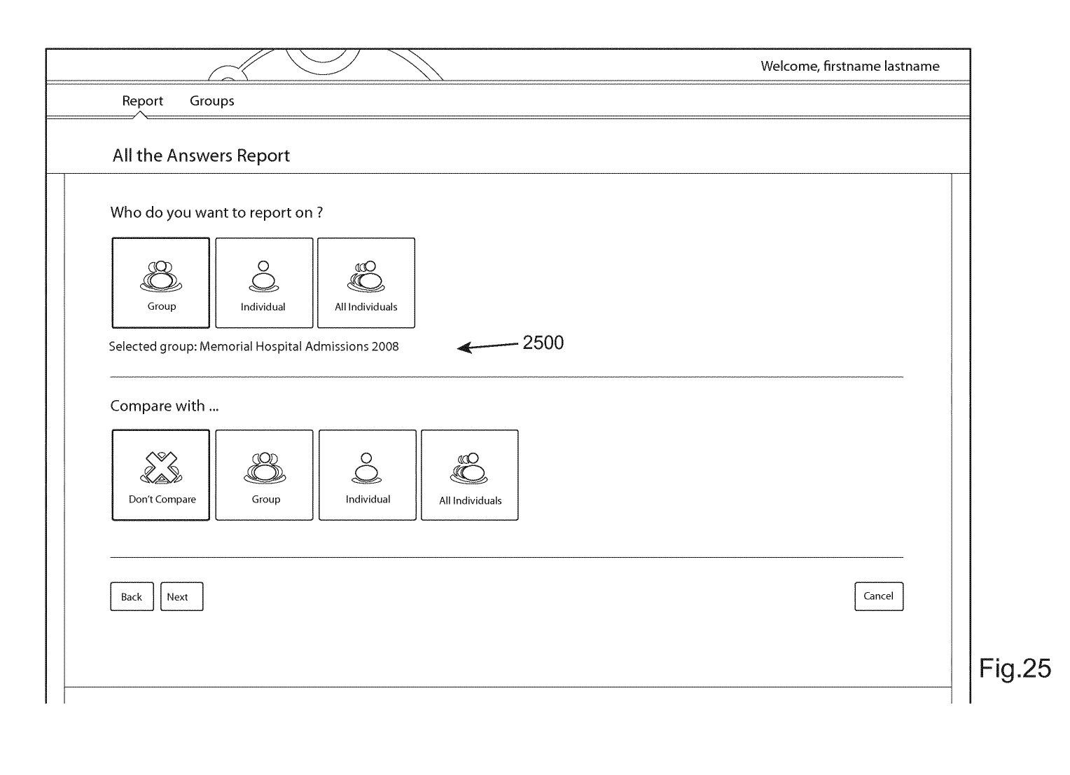

FIG. 24 shows the application of the time frame selection 2301 when creating a report using the report manager. Specifically, FIG. 24 shows “before Apr. 10, 2013 include data from visits that . . . ”. In the example the date range and visit options such as “started but did not finish” selected are the same as FIG. 23 but of course they could both be different to the settings applied in the creation of a group of individuals using the group manager feature shown in FIG. 23. In a similar manner as described with regard to FIG. 23, when a user has finished setting the time range, the user can create a report, which essentially involves querying the database by scanning the database for all entities/data associated with the at least one event that has occurred within at least one selected time frame boundary. In this way the user can create a report in which individuals are selected based upon a time frame relating to one set of object relationships and attributes but the data that is scanned for those individuals is data identified by a different time frame relating to a different set of object relationships and attributes. For example, the patients identified by the first time frame may be individuals with a certain diagnosis who visited Hospital A during 2008 but the data that is scanned in the report may be data pertaining to those individuals when they visited Hospital B during a different time period. Furthermore, the visits to Hospital B may be further limited according to the characteristics of those individuals at the time of visiting Hospital B. For example, the visits to Hospital B scanned may only be those visits where those patients had the same diagnosis as when they visited Hospital A. This feature has immediate everyday application within healthcare since, for example, a user of the system who is interested in patients with a diagnosis of diabetes who visited Hospital A during 2008 may only be interested in those patients' admissions to Hospital B for diabetes, rather than for any of the wide range of other medical conditions that may have led the patient to visit Hospital B. This aspect of the present teaching is best described with reference to FIGS. 25 to 28 as follows.

FIGS. 25 to 28 essentially show how many patients seen in a first group 2500—hospital A (Memorial Hospital) in 2008 were also present in a second group 2700 hospital B (St Marys Hospital) in the period 2010-2013 and died whilst in that hospital B in the 2010-2013 period. In FIG. 25, a user has selected a predefined group 2500 in the report manager that the user wishes to report on. The predefined group being all patients admitted to Memorial Hospital in 2008.

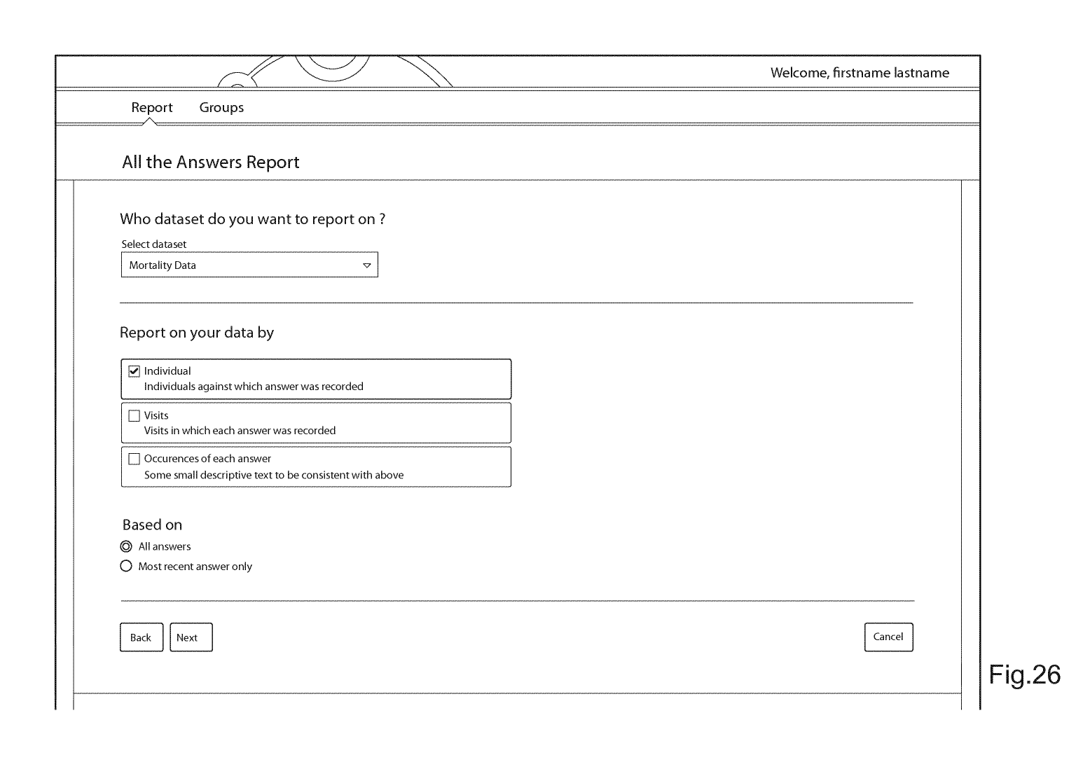

In FIG. 26, a user is presented with a number of options. As the user is interested in creating a report on all individuals that died, the options “Mortality data” “Individual” and “All answers” are chosen.

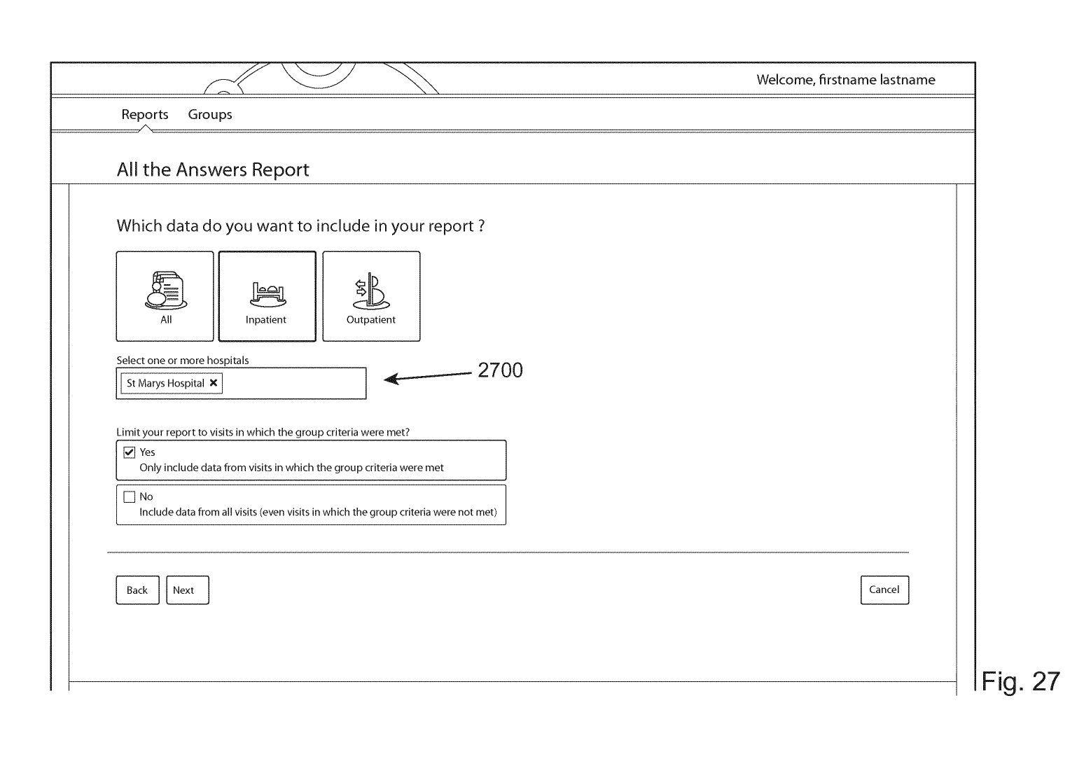

In FIG. 27, a user is given the opportunity to select the data to include in the report. As the user is interested in all the mortalities of patients admitted to St Marys Hospital then the options “Inpatient” and “St Marys Hospital” are selected.

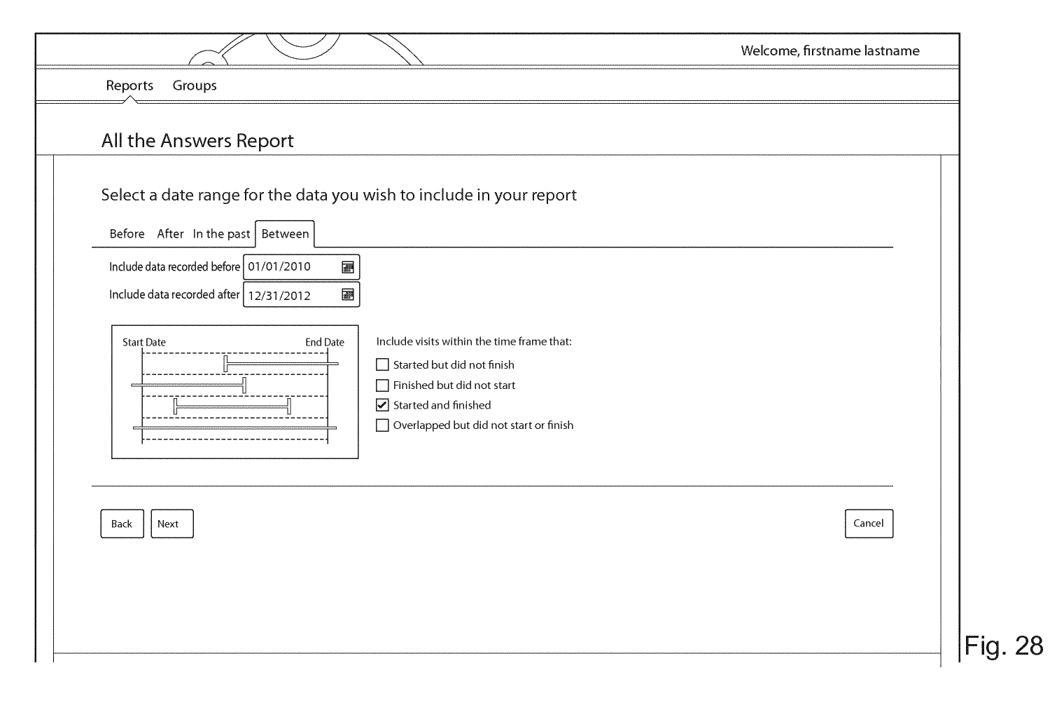

In FIG. 28, the user is presented with options that allow them to define the time frame for the inpatient visits at St Marys Hospital. Therefore, as the user in interested in creating a report on inpatients who died during a visit in the period 2010-2013, these dates can be entered in the “Include data recorded before” and “Include data recorded after” calendar boxes, respectively. As the user in only interested in visits which both started and finished in this time period, the tick box “started and finished” is ticked. However, any of the other option such as “Started but did not finish” could be chosen. This option would refer to patients who started their visit in 2010-2013 but did not finish their visit until after 2013 i.e., these patients were still alive and continued their visit after 2013.

In summary, the above described database system and graphical user interfaces provide numerous advantages over the prior art. Information of the database is stored in such a manner that data for a query may be extracted far more rapidly than relational database storage schemas, and with an expression for each extracted record. The presence of this expression in the query result has an important effect. A unique reporting benefit gained is the scope for progressive and complex querying. The reporting or querying benefit allows a graphical user interface with an array of user selectable criteria to be provided to the user such that complex and progressive queries can be easily performed.

When a database query is executed to provide information for a report, the answer will be made up of a number of expression records. This subset of expressions inherits all the structural information held in the main expression set.

It will be understood that the database querying essentially requires byte wide comparison of the expressions I₁ to Iₙ (I₁ to I₁₅ simply used as an example above). An extremely fast coprocessor ASIC could thus be manufactured which includes up to n eight-bit comparators in parallel. In practice, querying would never require all fifteen bytes to be compared, as most queries involve the setting of a large number of the bytes to a non-deterministic state, thus in practice requiring fewer parallel circuits and enabling simplification of the design of a dedicated co-processor. This allows near instantaneous results at the graphical user interface.

While it is not intended to limit the present teaching to any one specific arrangement it will be appreciated that multiple types of queries that were heretofore difficult to generate in a simple user interface may now be provided. For example it is possible to progressively generate a plurality of queries to extract data from the database, a first query providing a subset of the plurality of unique, multi-character expressions, the subset being used to create a dataset in a results table for interrogation by a second query. Another arrangement is generating a user query in the form of a syntactically correct statement, the database system being configured to interrogate the user query and transform the user query to identify one or more of the plurality of unique, multi-character expressions which satisfy the query. A further arrangement may provide storing a plurality of individual unique, multi-character expressions having data related to a specific person and parsing the plurality of unique, multi-character expressions to extract information not wholly stored in any one of the unique, multi-character expressions. Another arrangement may provide storing a plurality of individual unique, multi-character expressions having data related to a specific event and parsing the plurality of unique, multi-character expressions to extract information not wholly stored in any one of the unique, multi-character expressions and defined within a queried data window.

In addition, although not described in detail in the present application the graphical user interface also allows a user to input records to the database.

It is also possible in accordance with the present teaching to provide a controlling of the output of a display of search results according to “event views” and “key views” or indeed to provide a profile of a user of the system and then controlling the output of display of search results according to the individual user.

While it is not intended to limit the present teaching to any one specific implementation it will be appreciated that the architecture is typically a distributed architecture where the database is provided as a cloud database.

The words “comprises/comprising” and the words “having/including” when used herein with reference to the present invention are used to specify the presence of stated features, integers, steps or components but does not preclude the presence or addition of one or more other features, integers, steps, components or groups thereof.

The present teaching is not limited to the embodiments hereinbefore described but may be varied in both construction and detail.

1. A method of querying a database with a graphical user interface comprising the steps of:
defining a data model representative of the data to be stored within the database, the data model defined in accordance with a hierarchical structure and protocol and comprising a plurality of hierarchical levels defined within a tree structure;
defining, for each entity of a plurality of entities within the data model, a multi-character expression to specify each entity, attribute and occurrence of said each entity, the multi-character expression providing a unique label to each entity, each attribute and each occurrence of each entity and implicitly encoding the data model by reference to the hierarchical structure and protocol;
storing data defined by the model within the database;
scanning a portion of the database defining a first group, with a database multi-byte query expression comprising a plurality of deterministic bytes and a plurality of non-deterministic bytes;
generating and displaying on the graphical user interface, in response to the scanning, a set of results defining at least one sub group, the set of results corresponding to each multi-character expression within the database having characters matching the deterministic bytes of the multi-byte query;
allowing a user to select and store the displayed at least one sub group; and
allowing a user to select the stored sub group as a group on which at least one query is to be performed.

2. The method of claim 1, wherein the database query expression is generated in response to a user input provided through the graphical user interface provided to the user to allow a user select at least one displayed criterion.

3. The method of claim 2, where the database query expression is generated in response to a user input effect through an iterative user selection of displayed criteria.

4. The method of claim 3, where the criteria are segregated as scope criteria and descriptive filters.

5. The method of claim 1, wherein allowing a user to select the stored sub group as a group on which at least one query is to be performed comprises displaying the stored sub group in a tree structure including the first group.

6. The method of claim 5, wherein the tree structure is displayed including any other previously created groups or sub groups.

7. The method of claim 1, wherein displaying the set of results comprises displaying a graphical representation of the set of results.

8. The method of claim 5, wherein allowing a user select the displayed at least one sub group comprises determining in response to a user interaction with the graphical user interface a user selected portion of a graphical representation of the data displayed on the graphical user interface.

9. The method of claim 7, where the graphical representation is a bar chart.

10. The method of claim 8, wherein the graphical representation is a bar chart and allowing the user select the displayed at least one sub group comprises in response to a user interaction with a graphical user interface determining a user selected column of the displayed bar chart.

11. The method of claim 7, where the graphical representation is any one of a pie chart, a histogram and a line chart.

12. The method of claim 1, wherein allowing a user to select and store the displayed at least one sub group comprises displaying a user editable text box for naming the at least one sub group prior to the storing of the sub group.

13. The method of claim 1, wherein allowing a user to select and store the set of results comprises displaying a user editable text box for describing at least one criterion used to generate the database query expression.

14. The method of claim 1, wherein the first group and sub group are groups of medical patients.

15. The method of claim 1, further comprising:
scanning at least a portion of a database defining the sub group, with a database query expression,
generating and displaying, in response to the scanning, a set of results defining at least one further sub group;
allowing a user to select and store the displayed at least one further sub group; and
allowing a user to select the stored further sub group as a group on which at least one query is to be performed.

16. A database system comprising a database and a graphical user interface, the database having stored therein a plurality of entities arranged within a defined data model, representative of the data to be stored within the database, the data model defined in accordance with a hierarchical structure and protocol and comprising a plurality of hierarchical levels defined within a tree structure; wherein for each entity of the plurality of entities stored within the database, a multi-character expression specifies each entity, attribute and occurrence of said each entity, the multi-character expression providing a unique label to each entity, each attribute and each occurrence of each entity and implicitly encoding the data model by reference to the hierarchical structure and protocol; the system being arranged to:
allow a user scan a portion of the database defining a first group, with a database multi-byte query expression comprising a plurality of deterministic bytes and a plurality of non-deterministic bytes;
generate and display on the graphical user interface, in response to the scan, a set of results defining at least one sub group, the set of results corresponding to each multi-character expression within the database having characters matching the deterministic bytes of the multi-byte query;
allow the user to select and store the displayed at least one sub group; and
allow the user to select the stored sub group as a group on which at least one query is to be performed.

16. The database system of claim 15, wherein the database query expression is generated in response to a user input provided through the graphical user interface provided to the user to allow a user select at least one displayed criterion.

17. The database system of claim 16, where the database query expression is generated in response to a user input effect through an iterative user selection of displayed criteria.

18. The database system of claim 17, where the criteria are segregated as scope criteria and descriptive filters.

19. The database system of claim 15, wherein allowing a user to select the stored sub group as a group on which at least one query is to be performed comprises displaying the stored sub group in a tree structure including the first group.

20. The database system of claim 19, wherein the tree structure is displayed including any other previously created groups or sub groups.

21. The database system of claim 15, wherein displaying the set of results comprises displaying a graphical representation of the set of results.

22. The database system of claim 15, wherein allowing a user to select the displayed at least one sub group comprises determining in response to a user interaction with the graphical user interface a user selected portion of a graphical representation of the data displayed on the graphical user interface.

23. The database system of claim 21, where the graphical representation is a bar chart.

24. The database system of claim 22, wherein the graphical representation is a bar chart and allowing the user select the displayed at least one sub group comprises in response to a user interaction with a graphical user interface determining a user selected column of the displayed bar chart.

25. The database system of claim 21, where the graphical representation is any one of a pie chart, a histogram and a line chart.

26. The database system of claim 15, wherein allowing a user to select and store the displayed at least one sub group comprises displaying a user editable text box for naming the at least one sub group prior to the storing of the sub group.

26. The database system of claim 15, wherein allowing a user to select and store the set of results comprises displaying a user editable text box for describing at least one criterion used to generate the database query expression.

27. The database system of claim 15, wherein the first group and sub group are groups of medical patients.

28. The database system of claim 15, wherein the user interface is further configured to:
scan at least a portion of a database defining the sub group, with a database query expression,
generate and display, in response to the scanning, a set of results defining at least one further sub group;
allow a user to select and store the displayed at least one further sub group; and
allow a user to select the stored further sub group as a group on which at least one query is to be performed.
